(19) United States
(12) Patent Application Publication
(10) Pub. No.: US 2026/0088934 A1
(43) Pub. Date: Mar. 26, 2026

(54) CODE-BLOCK BIT INTERLEAVING FOR FLEXIBLE SPECTRUM INTEGRATION OR CARRIER AGGREGATION SUB-BANDS

(71) Applicant: QUALCOMM Incorporated, San Diego, CA (US)

(72) Inventors: Kianoush HOSSEINI, San Diego, CA (US); Javier RODRIGUEZ FERNANDEZ, San Diego, CA (US); Mostafa KHOSHNEVISAN, San Diego, CA (US); Gokul SRIDHARAN, Sunnyvale, CA (US)

(21) Appl. No.: 18/895,262

(22) Filed: Sep. 24, 2024

(51) Int. Cl. H04L 1/00; H04L 5/00; H04W 72/231; H04W 72/541

(52) U.S. Cl. CPC H04L 1/0071; H04L 1/0061; H04L 5/0094; H04W 72/231; H04W 72/541

(57) ABSTRACT

Systems and techniques are provided for wireless communication. For example, a processing system of a network entity can be configured to receive information indicative of a mapping between an input code-block (CB) bit sequence and a plurality of sub-bands. The processing system can generate an interleaved CB bit sequence based on application of the mapping to a particular CB bit sequence, wherein each sub-band of the plurality of sub-bands is mapped to a respective subset of coded bits of a plurality of coded bits according to the mapping. The particular CB bit sequence includes the plurality of coded bits, and the plurality of coded bits includes a plurality of subsets of coded bits. The processing system can output, based on the interleaved CB bit sequence, a plurality of modulated symbols.

### INTRODUCTION

Aspects of the present disclosure generally relate to wireless communication. In some implementations, examples are described for bit-level interleaving for code-block (CB) bit sequences mapped to one or more sub-bands associated with flexible spectrum integration (FSI) and/or carrier aggregation (CA).

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, a network entity for wireless communication is provided. The network entity includes at a processing system, where the processing system is configured to: receive information indicative of a mapping between an input code-block (CB) bit sequence and a plurality of sub-bands; generate an interleaved CB bit sequence based on application of the mapping to a particular CB bit sequence, wherein each sub-band of the plurality of sub-bands is mapped to a respective subset of coded bits of a plurality of coded bits according to the mapping, wherein the particular CB bit sequence includes the plurality of coded bits, and wherein the plurality of coded bits includes a plurality of subsets of coded bits; and output, based on the interleaved CB bit sequence, a plurality of modulated symbols.

In another example, a method for wireless communication is provided, the method including: receiving information indicative of a mapping between an input code-block (CB) bit sequence and a plurality of sub-bands; generating an interleaved CB bit sequence based on application of the mapping to a particular CB bit sequence, wherein each sub-band of the plurality of sub-bands is mapped to a respective subset of coded bits of a plurality of coded bits according to the mapping, wherein the particular CB bit sequence includes the plurality of coded bits, and wherein the plurality of coded bits includes a plurality of subsets of coded bits; and outputting, based on the interleaved CB bit sequence, a plurality of modulated symbols.

In another example, a non-transitory computer-readable storage medium comprising instructions stored thereon which, when executed by at least one processor, causes the at least one processor to: receive information indicative of a mapping between an input code-block (CB) bit sequence and a plurality of sub-bands; generate an interleaved CB bit sequence based on application of the mapping to a particular CB bit sequence, wherein each sub-band of the plurality of sub-bands is mapped to a respective subset of coded bits of a plurality of coded bits according to the mapping, wherein the particular CB bit sequence includes the plurality of coded bits, and wherein the plurality of coded bits includes a plurality of subsets of coded bits; and output, based on the interleaved CB bit sequence, a plurality of modulated symbols.

In another example, an apparatus is provided for wireless communication. The apparatus includes: means for receiving information indicative of a mapping between an input code-block (CB) bit sequence and a plurality of sub-bands; means for generating an interleaved CB bit sequence based on application of the mapping to a particular CB bit sequence, wherein each sub-band of the plurality of sub-bands is mapped to a respective subset of coded bits of a plurality of coded bits according to the mapping, wherein the particular CB bit sequence includes the plurality of coded bits, and wherein the plurality of coded bits includes a plurality of subsets of coded bits; and means for outputting, based on the interleaved CB bit sequence, a plurality of modulated symbols.

In another illustrative example, a network entity for wireless communication is provided. The network entity includes at a processing system, where the processing system is configured to: transmit information indicative of a mapping between an input code-block (CB) bit sequence and a plurality of sub-bands; generate an interleaved CB bit sequence based on application of the mapping to a particular CB bit sequence, wherein each sub-band of the plurality of sub-bands is mapped to a respective subset of coded bits of a plurality of coded bits according to the mapping, wherein the particular CB bit sequence includes the plurality of coded bits, and wherein the plurality of coded bits includes a plurality of subsets of coded bits; output, based on the interleaved CB bit sequence, a plurality of modulated symbols; and transmit the plurality of modulated symbols using the plurality of sub-bands.

In another example, a method for wireless communication is provided, the method including: transmitting information indicative of a mapping between an input code-block (CB) bit sequence and a plurality of sub-bands; generating an interleaved CB bit sequence based on application of the mapping to a particular CB bit sequence, wherein each sub-band of the plurality of sub-bands is mapped to a respective subset of coded bits of a plurality of coded bits according to the mapping, wherein the particular CB bit sequence includes the plurality of coded bits, and wherein the plurality of coded bits includes a plurality of subsets of coded bits; outputting, based on the interleaved CB bit sequence, a plurality of modulated symbols; and transmitting the plurality of modulated symbols using the plurality of sub-bands.

In another example, a non-transitory computer-readable storage medium comprising instructions stored thereon which, when executed by at least one processor, causes the at least one processor to: transmit information indicative of a mapping between an input code-block (CB) bit sequence and a plurality of sub-bands; generate an interleaved CB bit sequence based on application of the mapping to a particular CB bit sequence, wherein each sub-band of the plurality of sub-bands is mapped to a respective subset of coded bits of a plurality of coded bits according to the mapping, wherein the particular CB bit sequence includes the plurality of coded bits, and wherein the plurality of coded bits includes a plurality of subsets of coded bits; output, based on the interleaved CB bit sequence, a plurality of modulated symbols; and transmit the plurality of modulated symbols using the plurality of sub-bands.

In another example, an apparatus is provided for wireless communication. The apparatus includes: means for transmitting information indicative of a mapping between an input code-block (CB) bit sequence and a plurality of sub-bands; means for generating an interleaved CB bit sequence based on application of the mapping to a particular CB bit sequence, wherein each sub-band of the plurality of sub-bands is mapped to a respective subset of coded bits of a plurality of coded bits according to the mapping, wherein the particular CB bit sequence includes the plurality of coded bits, and wherein the plurality of coded bits includes a plurality of subsets of coded bits; means for outputting, based on the interleaved CB bit sequence, a plurality of modulated symbols; and means for transmitting the plurality of modulated symbols using the plurality of sub-bands.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment (UE), in accordance with some examples;

FIG. 5 is a diagram illustrating an example of physical channels and reference signals in a wireless network, in accordance with some examples;

FIG. 6 is a diagram illustrating an example of carrier aggregation (CA) and flexible spectrum integration (FSI) in a wireless network, using sub-bands corresponding to CA component carriers (CAs) or FSI virtual cell and/or virtual carrier sub-bands, in accordance with some examples;

FIG. 7A is a diagram illustrating an example of transport block (TB) scheduling corresponding to FSI with single physical downlink shared channel (PDSCH) and/or physical uplink shared channel (PUSCH) scheduling and mapping, in accordance with some examples;

FIG. 7B is a diagram illustrating an example of TB scheduling corresponding to FSI with multi-subband (multi-SB) scheduling, in accordance with some examples;

FIG. 8 is a diagram illustrating an example of per-subband (per-SB) bit interleaving for a code block (CB) bit sequence based on a mapping between the coded bits and a set of sub-bands (SBs), where the bits mapped to each SB are interleaved using a corresponding block interleaver for the SB, in accordance with some examples;

FIG. 9 is a diagram illustrating an example of combined bit interleaving for a CB bit sequence based on a mapping between the coded bits and a set of SBs, where the bits mapped to each SB are interleaved using different portions and/or different configurations of a single block interleaver for all SBs, in accordance with some examples;

FIG. 10 is a flow diagram illustrating an example of a process for wireless communication, in accordance with some examples;

FIG. 11 is a flow diagram illustrating another example of a process for wireless communication, in accordance with some examples; and

FIG. 12 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

A wireless device may support carrier aggregation (CA). For example, carrier aggregation can be based on the wireless device performing simultaneous operation on multiple carriers. A wireless device (e.g., UE) implementing carrier aggregation may support simultaneous operation on multiple bands, including multiple bands being used amongst different modes (e.g., different pairs of bands). Carrier aggregation can be used to combine multiple frequency carriers to increase bandwidth, improve data rates, etc. Carrier aggregation can be implemented using multiple component carriers (CCs) that are aggregated for uplink and/or downlink operations between a network entity and a UE. For example, in 5G NR, carrier aggregation may be performed to aggregate up to 16 CCs, each with a bandwidth of up to 100 MHz in FR1 (e.g., sub-6 GHz frequency range), or up to 400 MHz in FR2 (e.g., mmWave). The aggregation of the multiple CCs can be implemented under a single scheduler.

In intra-band contiguous CA, the aggregated CCs are selected to be adjacent within the same frequency band. In intra-band non-contiguous CA, the aggregated CCs are selected from within the same frequency band but are not adjacent. In inter-band CA, the aggregated CCs are in different frequency bands. Various carrier aggregation techniques can correspond to using the resources within each CC as disjoint sets of resources, with separate physical layer (PHY) and media access control layer (MAC) operations performed for each CC. For example, the number of PHY and/or MAC operations associated with a CA implementation can scale linearly with the number of CCs that are being aggregated.

Flexible spectrum integration (FSI) can be implemented to integrate multiple CCs (e.g., within the same or different bands) to form a virtual carrier or virtual cell. As used herein, the terms “virtual carrier” and “virtual cell” may be used interchangeably. The virtual cell can include resources from within the same band, and/or can include resources from within different bands. The virtual cell can include resources that are contiguous and/or non-contiguous. For example, a plurality of different CCs can be configured as respective sub-bands (SBs) within the virtual carrier or virtual cell of the FSI implementation.

The virtual carrier (e.g., virtual cell) can be used as a single cell from the perspective of scheduling operations and hybrid automatic repeat request (HARQ) transmissions. For example, the virtual carrier can include a plurality of sub-bands (SBs), where each SB is one physical carrier or a portion thereof (e.g., a portion of one physical carrier). In some examples, the SBs associated with FSI can be the same as the CCs associated with CA (e.g., a CC used for carrier aggregation can be an SB used for FSI and/or included within a virtual carrier or virtual cell, and vice versa). The multiple SBs within a virtual cell are configured as a single scheduling and HARQ entity to the network, and, unlike in CA implementations, the number of PHY and/or MAC operations performed for the aggregated bandwidth of the virtual cell does not necessarily increase as the number of CCs or SBs aggregated within the virtual cell increases.

In some cases, the virtual cell can be configured as one scheduling and HARQ entity to the network, with one CC of physical downlink control channel (PDCCH) transmissions used for scheduling associated with the virtual cell and aggregated SBs within the virtual cell. A virtual cell including a particular number of SBs within the aggregated bandwidth of the virtual cell may be implemented with a smaller number of decoding attempts by a UE than would be performed by the UE if the same number of SBs were to be configured as the respective aggregated CCs for a carrier aggregation implementation.

For example, CA performed for a plurality of SBs (e.g., CCs) may correspond to a UE detecting or performing blind decoding for a control resource set (CORESET) within each respective SB of the plurality of SBs. FSI and/or a virtual cell configured for the same plurality of SBs can correspond to the UE detecting a single CORESET for the virtual cell (e.g., a single CORESET shared across each SB of the plurality of SBs).

In CA implementations, scheduling on each CC within the aggregated bandwidth can be adapted independently (e.g., where the adaptation or adjustment may correspond to the respective channel and/or interference conditions for a particular CC), for example with link parameters configured and/or adjusted separately for each CC that is configured for carrier aggregation. In some cases, a virtual carrier or virtual cell associated with an FSI implementation does not support independent configuration, adaptation, adjustment, etc., of the scheduling and/or link parameters used for the aggregated SBs included in the plurality of SBs within the virtual cell. For example, CA implementations may support the flexible and independent adaptation of link parameters on each CC, based on the CA implementations performing separate PHY/MAC operations for each CC. In some examples, FSI-based implementations of a virtual cell configure a plurality of SBs (e.g., CCs) as a single scheduling and HARQ entity, thereby reducing the number of PHY/MAC operations performed but removing support for the ability to perform independent adaptation of link parameters on each SB. In such examples, adaptation of link parameters may be performed on the virtual cell level, where a selected link parameter adjustment is applied to the virtual cell as the single scheduling and HARQ entity (e.g., the selected link parameter adjustment is applied to the virtual cell entity, which corresponds to applying the same selected link parameter adjustment to each SB of the plurality of SBs aggregated within the virtual cell). There is a need for systems and techniques that can be used to implement link parameter adjustments and/or adaptations at the sub-band level of a virtual cell comprising a plurality of aggregated SBs. There is a further need for systems and techniques that can be used to implement link parameter adjustments and/or adaptations based on channel conditions, interreference conditions, etc., that are determined for individual SBs within a virtual cell.

Systems, apparatuses, processes (also referred to as methods), and computer-readable media (collectively referred to as “systems and techniques”) are described herein that can be used to provide code-block bit interleaving for flexible spectrum integration or carrier aggregation sub-bands. For example, the systems and techniques can be used to implement link parameter adjustments at the sub-band level of a virtual cell comprising a plurality of aggregated sub-bands, based on applying a configured mapping between an input bit sequence and the plurality of sub-bands of the virtual cell. In some cases, the mapping can be based on channel conditions and/or interference conditions that are determined or obtained for each respective SB of the plurality of SBs aggregated within a virtual cell.

For example, the most significant bits (MSBs) of an input code-block (CB) bit sequence can be mapped to SBs of the virtual cell with relatively better link parameters, and the least significant bits (LSBs) of the input CB bit sequence can be mapped to SBs of the virtual cell having relatively worse link parameters. In some cases, systematic bits (e.g., information bits) of the input CB bit sequence can be mapped to SBs of the virtual cell with relatively better link parameters, and parity bits (e.g., error detection and/or error correction bits) of the input CB bit sequence can be mapped to SBs of the virtual cell with relatively worse link parameters. In some examples, MSBs and LSBs of the CB bit sequence can be distributed across the SBs of the virtual cell, with a subset of SBs of the virtual cell associated with relatively better link parameters being mapped to a corresponding subset of the MSBs and LSBs, and with a second subset of SBs of the virtual cell associated with relatively worse link parameters being mapped to another corresponding subset of MSBs and LSBs. In some examples, the systematic bits and parity bits can additionally be distributed (e.g., mapped) across the various SBs and corresponding link quality and link parameters within the plurality of SBs of the virtual cell.

In some aspects, a UE may receive information indicative of a mapping between an input CB bit sequence and a plurality of SBs associated with a virtual cell configured for the UE. For example, the UE can receive the information indicative of the mapping from a network entity (e.g., base station, gNB, etc.) that is associated with the UE, where communications between the UE and the network entity are performed using the virtual cell. Based on the configured mapping indication, the UE can apply the mapping to a particular CB bit sequence associated with communications using the virtual cell. For example, the configured mapping indication can be used to map coded bits to respective SBs of the virtual cell, with modulated symbols generated for the coded bits mapped to each sub-band and used for an UL transmission from the UE to the base station using the virtual cell. In another example, the configured mapping indication can be used by the UE to decode (e.g., recover) an original sequence of coded bits from a DL transmission received by the UE from the network entity using the virtual cell. In some aspects, the same mapping (e.g., the same mapping configuration and/or mapping indication) can be used to code UL transmissions from the UE to the base station, and to decode DL transmissions from the base station to the UE. The same mapping can be used by the UE and the base station that perform communications using the virtual cell.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, a processing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, processing system, or the like may include disclosure of the UE, base station, apparatus, device, computing system, processing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first processing system, a first one or more components, a first processing entity, or the like configured to receive the information; and the second network node may refer to a second UE, a second base station, a second apparatus, a second device, a second computing system, a second processing system, a second one or more components, a second processing entity, or the like.

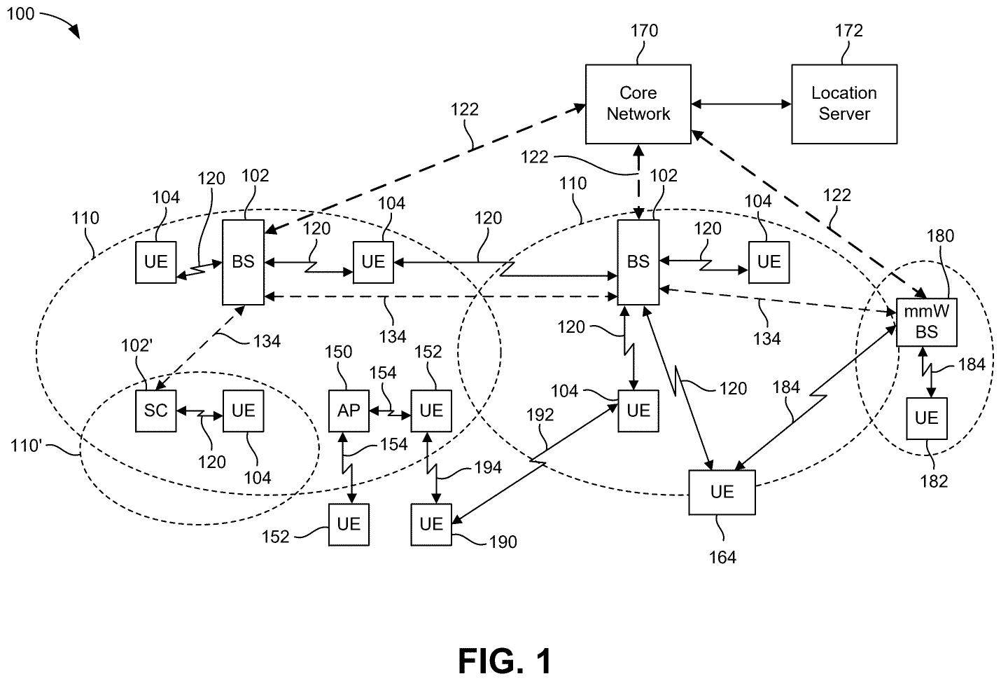

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, a processing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 100 of FIG. 1. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, network node, apparatus, device, computing system, processing system or the like may include disclosure of the UE, base station, network node, apparatus, device, computing system, processing system or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first processing system, a first set of one or more one or more components, a first processing entity, or the like configured to receive the information; and the second network entity may refer to a second UE, a second base station, a second apparatus, a second device, a second computing system, a second processing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

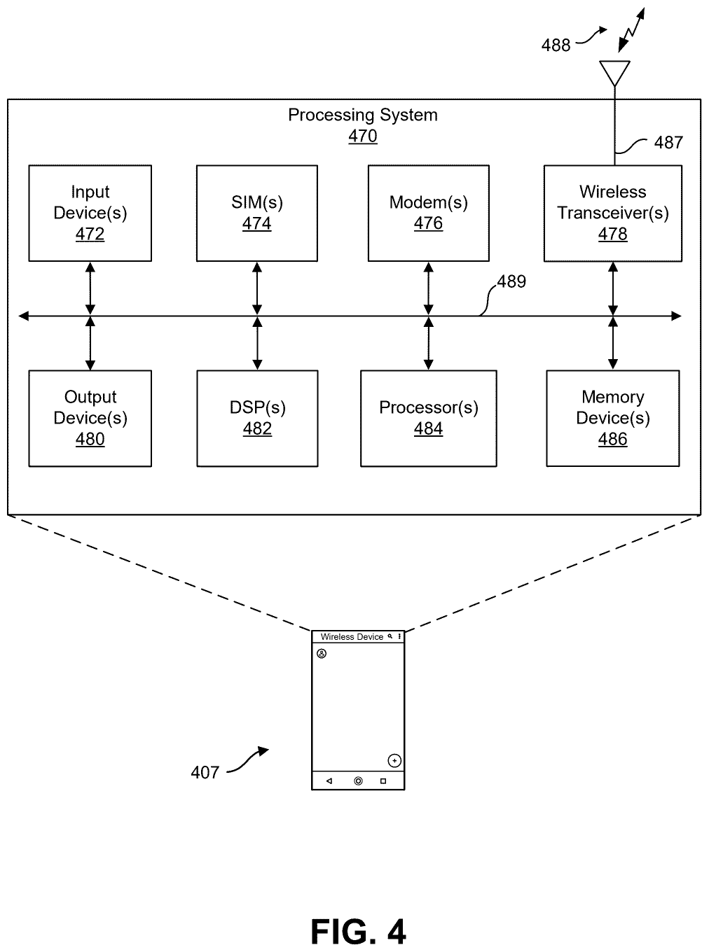

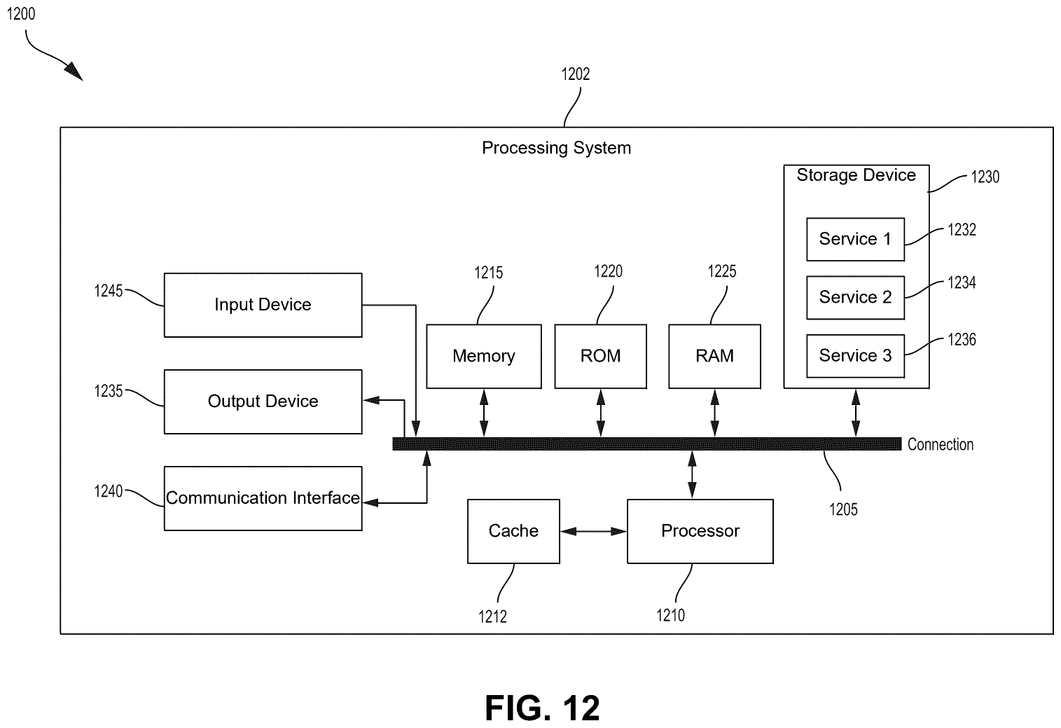

In some examples, the network entity 102 may include a processing system (e.g., such as the processing system 470 of FIG. 4 and/or the processing system 1202 of FIG. 12, etc.). Similarly, the network entity 180 (e.g., a millimeter wave (mmW) base station, etc.) may include a respective processing system (e.g., such as the processing system 470 of FIG. 4 and/or the processing system 1202 of FIG. 12, etc.). A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 102 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

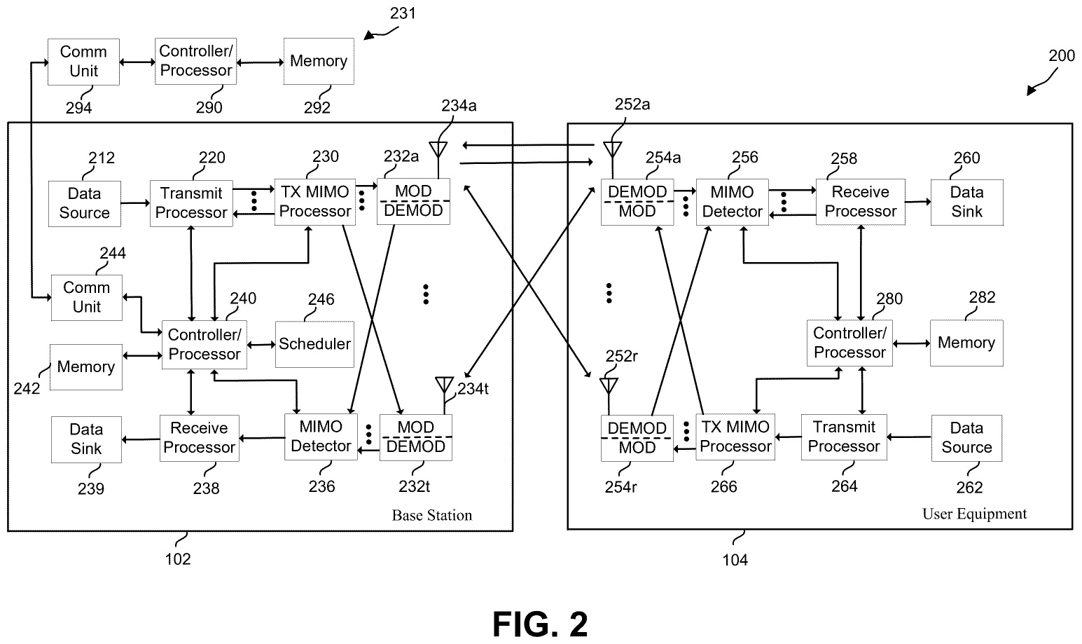

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

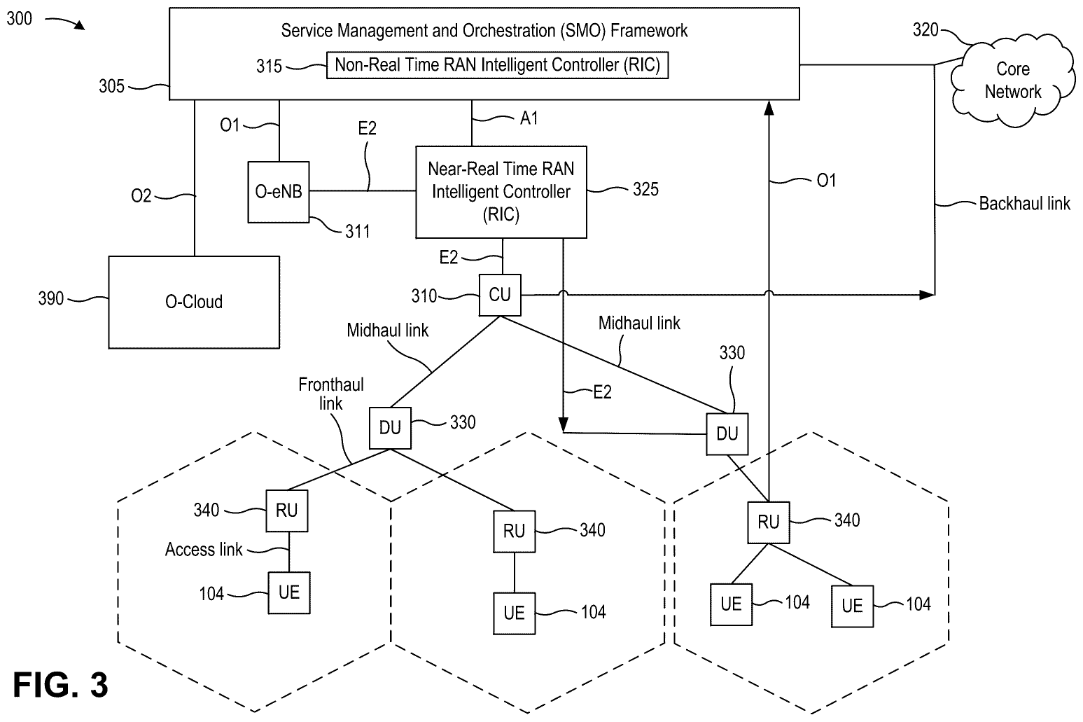

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUs 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit—User Plane (CU-UP)), control plane functionality (e.g., Central Unit—Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via O1) or via creation of RAN management policies (e.g., such as A1 policies).

FIG. 4 illustrates an example of a processing system 470 of a wireless device 407. In some examples, the processing system 470 may also be referred to as a computing system. The processing system 470 may include and/or implement one or more components that are the same as or similar to respective components included in and/or implemented by the processing system 1202 of FIG. 12 (e.g., and the processing system 1202 of FIG. 12 may include and/or implement one or more components that are the same as or similar to respective components included in and/or implemented by the processing system 470 of FIG. 4). In some cases, the wireless device 407 may also be referred to as a user computing device. The wireless device 407 may include a client device such as a UE (e.g., UE 104, UE 152, UE 190) or other type of device (e.g., a station (STA) configured to communication using a Wi-Fi interface) that may be used by an end-user. In some cases, the processing system 470 of the wireless device 407 can be implemented by one or more of the UEs 104 of FIG. 1. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network.

The processing system 470 includes software and hardware components that may be electrically or communicatively coupled via a bus 489 (e.g., or may otherwise be in communication, as appropriate). The processing system 470 may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. For example, the processing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The processing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, processing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the processing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the processing system 470 may include a coding-decoding device (or CODEC) configured to encode and/or decode data transmitted and/or received using the one or more wireless transceivers 478. In some cases, the processing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The processing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The processing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

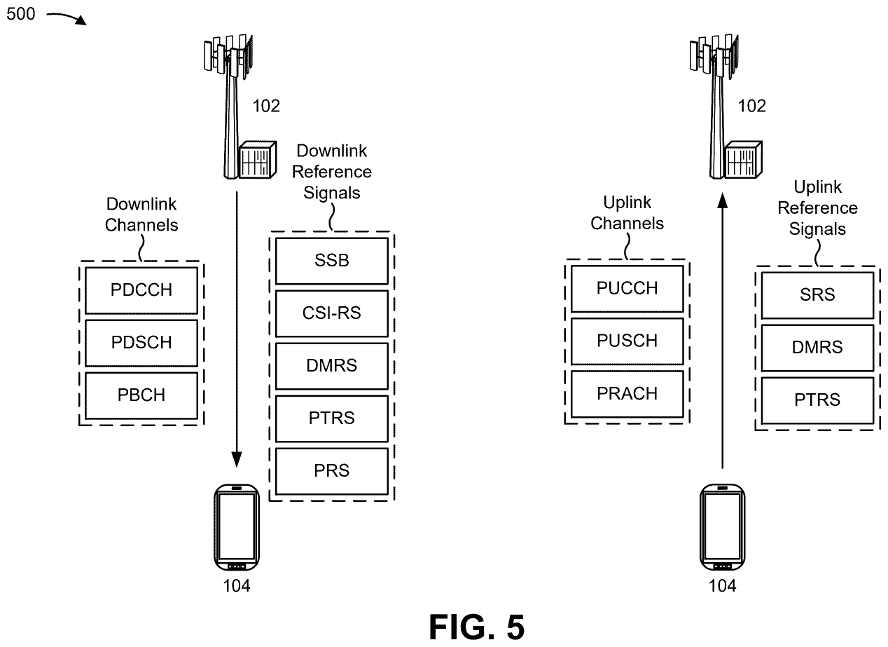

FIG. 5 is a diagram illustrating an example 500 of physical channels and reference signals in a wireless network. In some examples, one or more downlink channels and one or more downlink reference signals may carry information from a base station 102 to a UE 104. One or more uplink channels and one or more uplink reference signals may carry information from UE 104 to base station 102.

In some aspects, a downlink channel may include one or more of a physical downlink control channel (PDCCH) that carries downlink control information (DCI), a physical downlink shared channel (PDSCH) that carries downlink data, and/or a physical broadcast channel (PBCH) that carries system information, among other examples. In some aspects, PDSCH communications may be scheduled by PDCCH communications.

In some examples, an uplink channel may include one or more of a physical uplink control channel (PUCCH) that carries uplink control information (UCI), a physical uplink shared channel (PUSCH) that carries uplink data, and/or a physical random access channel (PRACH) used for initial network access, among other examples. In some aspects, UE 104 may transmit acknowledgement (ACK) or negative acknowledgement (NACK) feedback (e.g., ACK/NACK feedback or ACK/NACK information) in UCI on the PUCCH and/or the PUSCH.

In some cases, a downlink reference signal may include one or more of a synchronization signal block (SSB), a channel state information (CSI) reference signal (CSI-RS), a demodulation reference signal (DMRS), a positioning reference signal (PRS), and/or a phase tracking reference signal (PTRS), among other examples. In some examples, an uplink reference signal may include one or more of a sounding reference signal (SRS), a DMRS, and/or a PTRS, among other examples.

An SSB may carry or include information used for initial network acquisition and synchronization. For example, an SSB can carry or include one or more of a primary synchronization signal (PSS), a secondary synchronization signal (SSS), a PBCH, and/or a PBCH DMRS. An SSB may also be referred to as a synchronization signal/PBCH (SS/PBCH) block. In some aspects, base station 102 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. For example, base station 102 can configure a set of CSI-RSs for UE 104, and UE 104 can measure the configured set of CSI-RSs. Based on the CSI-RS measurements, UE 104 can perform channel estimation and report channel estimation parameters to base station 102 (e.g., in a CSI report). For example, the channel estimation parameters can include one or more of a channel quality indicator (CQI), a precoding matrix indicator (PMI), a CSI-RS resource indicator (CRI), a layer indicator (LI), a rank indicator (RI), and/or a reference signal received power (RSRP), among other examples.

In some examples, base station 102 can use the CSI report to select transmission parameters for downlink communications to UE 104. For example, base station 102 can use the CSI report to select transmission parameters that include one or more of a quantity of transmission layers (e.g., a rank), a precoding matrix (e.g., a precoder), a modulation and coding scheme (MCS), and/or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS can carry information used to compensate for oscillator phase noise. In some cases, oscillator phase noise may increase as an oscillator carrier frequency increases. In some examples, a PTRS can be utilized at high carrier frequencies (e.g., such as millimeter wave frequencies) to mitigate oscillator phase noise. The PTRS may be used to track the phase of the local oscillator and to enable suppression of phase noise and common phase error (CPE). As illustrated in FIG. 5, in some examples one or more PTRSs can be used for both downlink communications (e.g., on the PDSCH) and uplink communications (e.g., on the PUSCH).

A PRS may carry information associated with timing or ranging measurements of UE 104. For example, UE 104 may utilize one or more signals (e.g., PRSs) transmitted by base station 102 to improve an observed time difference of arrival (OTDOA) positioning performance. In some examples, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). A PRS can be designed to improve detectability by ULE 104, which may need to detect downlink signals from multiple neighboring base stations in order to perform OTDOA-based positioning. Accordingly, UE 104 may receive a PRS from multiple cells (e.g., a reference cell and one or more neighbor cells), and may report a reference signal time difference (RSTD) based on OTDOA measurements associated with the PRSs received from the multiple cells. In some aspects, base station 102 can calculate a position of UE 104 based on the RSTD measurements reported by UE 104.

In some examples, an SRS can carry information used for uplink channel estimation, which may be used for scheduling, link adaptation, precoder selection, and/or beam management, among other examples. Base station 102 can configure one or more SRS resource sets for ULE 104, and UE 104 can transmit SRSs on the configured SRS resource sets. An SRS resource set may have a configured usage, such as uplink CSI acquisition, downlink CSI acquisition for reciprocity-based operations, uplink beam management, among other examples. Base station 102 may measure the SRSs, may perform channel estimation based on the measurements, and/or may use the SRS measurements to configure communications with ULE 104.

As noted above, systems and techniques are described herein that can be used to provide code-block bit interleaving for flexible spectrum integration (FSI) sub-bands (SBs) and/or component carriers (CCs) (e.g., such as CCs associated with CA, etc.), where the code-block bit interleaving is implemented according to a configured mapping transmitted from a network entity (e.g., base station, gNB, etc.) to a UE. In some examples, the configured mapping can be used to map each sub-band of a plurality of sub-bands (e.g., SBs associated with CA and/or with a virtual cell or virtual carrier for FSI) to a corresponding subset of coded bits included in a CB bit sequence that is transmitted or received using the plurality of sub-bands. For example, the subsets of coded bits can be mapped to the respective SBs based on information associated with the coded bits (e.g., bit position within the CB bit sequence, MSB or LSB bit, MSB to LSB bit order, systematic or parity bit, etc.) and/or based on link parameter information obtained or determined for the respective SB (e.g., channel information, interference information, link parameter information, etc.).

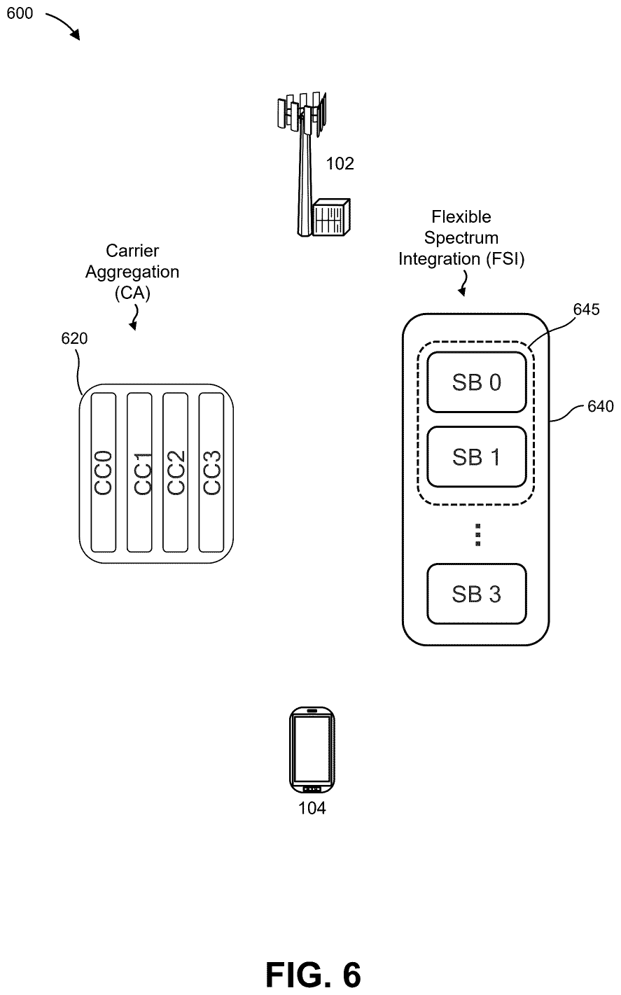

FIG. 6 is a diagram illustrating an example 600 of an aggregated bandwidth 620 associated with carrier aggregation (e.g., also referred to as a CA bandwidth or aggregated CA bandwidth) and an aggregated bandwidth for a virtual cell 640 (e.g., also referred to as a virtual carrier). The virtual cell 640 can be associated with flexible spectrum integration (FSI) in a wireless network including the network entity (e.g., base station, gNB, etc.) 102 and the ULE 104. For example, communications between the base station 102 and the UE 104 can be performed using the virtual cell 640. The aggregated CA bandwidth 620 can be associated with carrier aggregation in the same wireless network that includes the base station 102 and the UE 104. For example, communications between the base station 102 and the UE 104 can be performed using the aggregated CA bandwidth 620. In some aspects, carrier aggregation can be a type of FSI and/or an FSI technique.

As noted above, carrier aggregation can be implemented using multiple component carriers (CCs) that are aggregated for uplink and/or downlink operations between a network entity (e.g., base station 102) and a UE (e.g., UE 104). For example, in 5G NR, carrier aggregation may be performed to aggregate up to 16 CCs, each with a bandwidth of up to 100 MHz in FR1 (e.g., sub-6 GHz frequency range), or up to 400 MHz in FR2 (e.g., mmWave). The aggregation of the multiple CCs can be implemented under a single scheduler.

In one illustrative example, the aggregated CA bandwidth 620 can include a plurality of aggregated component carriers (CCs). For example, the aggregated CA bandwidth 620 includes the four CCs CC0, CC1, CC2, and CC3. The aggregated component carriers CC0-CC3 can be adjacent carriers from within the same frequency band, corresponding to an intra-band contiguous CA configuration for the aggregated CA bandwidth 620. In another example, the aggregated component carriers CC0-CC3 can be non-adjacent carriers from within the same frequency band, corresponding to an intra-band non-contiguous CA configuration. In another example, the aggregated component carriers CC0-CC3 can be adjacent or non-adjacent carriers that are in different frequency bands, corresponding to an inter-band CA configuration. In some aspects, CCs associated with carrier aggregation can be used as respective sub-bands (SBs) for a virtual cell or virtual carrier. For example, the virtual cell 640 includes the plurality of SBs SB0, SB1, . . . , SB3, etc. In some aspects, the plurality of SBs aggregated within the virtual cell 640 may be component carriers. In some examples, the plurality of SBs within the virtual cell 640 can be the same as or similar to one or more of the component carriers CC)-CC3 within the aggregated CA bandwidth 620. Various carrier aggregation techniques can correspond to using the resources within each CC as disjoint sets of resources, with separate physical layer (PHY) and media access control layer (MAC) operations performed for each CC. For example, the number of PHY and/or MAC operations associated with a CA implementation can scale linearly with the number of CCs that are being aggregated.

As used herein, a sub-band (SB) can refer to a sub-band that is included within a virtual cell or virtual carrier, where the virtual cell/carrier SB is one physical carrier or a portion of a physical carrier. As used herein, an SB can also refer to a physical carrier (or portion thereof) that is configured as a component carrier for carrier aggregation (e.g., an SB can be a CA CC, and a CA CC can be an SB, etc.). As used herein, an interleaver may, in some aspects, refer to a systematic bit priority mapping (SBPM) block interleaver. In other aspects, an interleaver may refer to an interleaver different from an SBPM interleaver. In some examples, an interleaver may refer to an interleaving engine and/or an interleaving function, including various functions configured to receive an input comprising a plurality of coded bits arranged in a first sequence (e.g., a first order of the plurality of coded bits), and configured to generate an output comprising the plurality of coded bits arranged in a second sequence different from the first sequence (e.g., a second order of the plurality of coded bits, different from the first order of the plurality of coded bits). In some cases, an interleaving function can include various functions configured to receive a plurality of coded bits as an input sequence, and change the ordering of the plurality of coded bits in an output sequence (e.g., configured to change the ordering of the plurality of coded bits in the output sequence, relative to the input sequence).

Flexible spectrum integration (FSI) can be implemented to integrate multiple SBs and/or CCs to form a virtual carrier or virtual cell. For example, the virtual cell 640 can be an integration of CCs (e.g., SBs) in the same or different bands, to form the single virtual carrier/cell 640. The virtual cell 640 can be implemented as a single cell for scheduling and/or HARQ operations performed by the wireless network. For example, the UE 104 and the base station 102 can perform communications using the virtual cell 640 as a single cell (e.g., the virtual cell 640 is used as a single scheduling and HARQ entity). As used herein, the terms “virtual carrier” and “virtual cell” may be used interchangeably.

The virtual cell 640 can include resources (e.g., respective resources included within and/or associated with each respective SB of the plurality of SBs SB0, SB1, . . . , SB3, etc.) from within the same band, and/or can include resources from within different bands. The virtual cell 640 can include resources (e.g., SBs) that are contiguous and/or non-contiguous. For example, a plurality of different CCs can be configured as respective sub-bands (SBs) within the virtual carrier or virtual cell 640. The virtual cell 640 can be used as a single cell from the perspective of scheduling operations and hybrid automatic repeat request (HARQ) transmissions. For example, the virtual cell 640 can include the plurality of SBs SB0, SB1, . . . , SB3, etc., where each SB is one physical carrier or a portion thereof (e.g., a portion of one physical carrier). In some examples, the SBs (e.g., SB0-SB3) included within the virtual cell 640 can be the same as the CCs (e.g., CC0-CC3) included within the aggregated CA bandwidth 620 (e.g., a CC used for carrier aggregation can be an SB used for FSI and/or included within a virtual carrier or virtual cell, and vice versa). The multiple SBs within a virtual cell 640 are configured as a single scheduling and HARQ entity to the network (e.g., network entity or base station 102), and, unlike in CA implementations, the number of PHY and/or MAC operations performed for the aggregated bandwidth of the virtual cell 640 does not necessarily increase as the number of CCs or SBs aggregated within the virtual cell 640 increases.

In some aspects, SB0 and SB1 of the virtual cell 640 can comprise a non-contiguous active bandwidth part (BWP) 645. For example, SB0 and SB1 can be included within the non-contiguous active BWP 645, which is configured for the single scheduling and HARQ entity comprising the virtual cell 640. In some cases, the virtual cell 640 can receive one CC of PDCCH transmission(s) for scheduling. In some cases, the UE 104 can perform communications with the base station 102 with a smaller number of decoding attempts, based on the UE 104 performing the communications with the base station 102 using the single entity of the virtual cell 640. The virtual cell 640 can be associated with a narrow RF range for PDCCH transmissions, with the UE 104 configured to only open its RF when there is data. In some cases, the virtual cell 640 utilizes one CORESET for the plurality of SBs SB0-SB3 included within the aggregated bandwidth of the virtual cell 640. The aggregated CA bandwidth 620 may include a respective CORESET for each CC (e.g., four CORESETs for the four CCs CC0-CC3 included within the aggregated CA bandwidth 620). For example, CA performed for a plurality of SBs (e.g., CCs) may correspond to the UE 104 detecting or performing blind decoding for a control resource set (CORESET) within each respective SB of the plurality of SBs. FSI and/or a virtual cell configured for the same plurality of SBs can correspond to the UE detecting a single CORESET for the virtual cell (e.g., a single CORESET shared across each SB of the plurality of SBs).

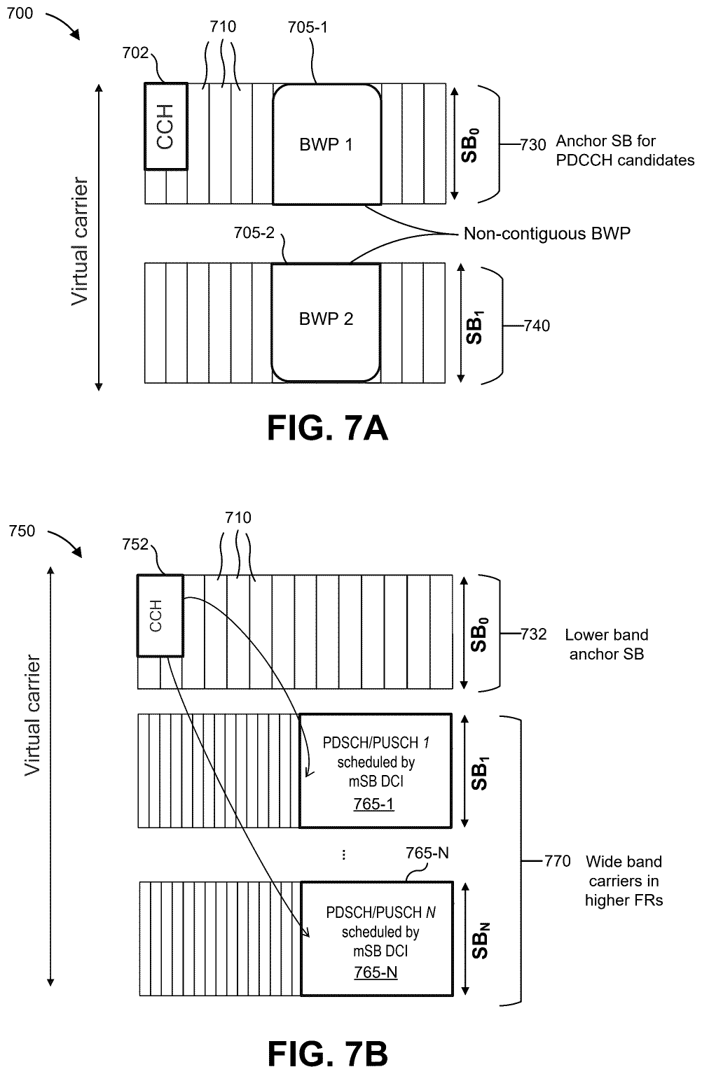

In some cases, the virtual cell 640 can be used for unifying re-transmissions (e.g., between base station 102 and UE 104) across SBs (e.g., across the plurality of SBs SB0-SB3, and/or various combinations and sub-combinations thereof) for improved diversity on the re-transmission attempt(s). Various types and configurations of transport block (TB) scheduling may be used across aggregated SBs of a virtual cell. For example, small and scattered frequency division duplexing (FDD) channels can be integrated as one large virtual carrier with single-TB scheduling, where the FDD channels each comprise one or more SBs of the virtual cell. An example of a virtual cell configured based on single-TB scheduling is described below with reference to FIG. 7A. In some examples, multi-TB scheduling can be performed with a single-CC PDCCH for a relatively larger (e.g., larger) aggregated bandwidth. In some aspects, a bandwidth part (BWP)-based bandwidth adaptation can be used for low-latency adaptation based on an RF bandwidth associated with the UE 104 and/or based on one or more configured measurements of wireless conditions, etc.

In single-TB scheduling and mapping, each TB is mapped onto a non-contiguous BWP activated within a virtual cell. The non-contiguous BWP that is activated within the virtual cell for the single-TB scheduling and mapping may include one or multiple SBs. For example, single-TB scheduling can be performed for the virtual cell 640 based on mapping a TB to the non-contiguous BWP 645 that includes SB0 and SB1.

FIG. 7A is a diagram illustrating an example of a virtual cell configuration 700 corresponding to single-TB scheduling, in accordance with some examples. In some cases, the virtual cell configuration 700 of FIG. 7A can correspond to transport block (TB) scheduling for FSI with single physical downlink shared channel (PDSCH) and/or physical uplink shared channel (PUSCH) scheduling and mapping.

The virtual cell configuration 700 of FIG. 7A can be associated with a virtual cell the same as or similar to the virtual cell 640 of FIG. 6. For example, the non-contiguous BWP comprising BWP 1 (e.g., a first BWP 705-1 within a first sub-band SB0 730) and BWP 2 (e.g., a second BWP 705-2 within a second sub-band SB1 740) can be activated within the virtual cell configuration 700 and used for single-TB scheduling.

The first SB0 730 of FIG. 7A can be the same as or similar to the first SB0 of the virtual cell 640 of FIG. 6, and the second SB1 740 of FIG. 7A can be the same as or similar to the second SB1 of the virtual cell 640 of FIG. 6. The first SB0 730 and the second SB1 740 can each include a plurality of time resources 710. For example, SB0 730 includes a plurality of time-frequency resources comprising the respective time resources 710 paired with frequency resources within the SB0 range of frequency resources, and SB1 740 includes a plurality of time-frequency resources comprising the respective time resources 710 paired with different frequency resources from SB0, where the different frequency resources for SB1 comprise the frequency resources within the SB1 range of frequencies.

SB0 730 and SB1 740 can be included in a virtual cell, and more particularly, can each include resources (e.g., BWP 705-1 and BWP 705-2, respectively) that are within a non-contiguous BWP configured and activated for single-TB scheduling for the virtual cell. For example, BWP 705-1 and BWP 705-2 can be included within or comprise the non-contiguous active BWP 645 of FIG. 6. In some cases, a scheduling PDCCH for the virtual cell may be transmitted and received using one CC worth of resources.

For example, the first sub-band within the virtual cell 700 and/or the first sub-band within the activated non-contiguous BWP of the virtual cell 700 can be referred to as the anchor sub-band. In the example of FIG. 7A, SB0 730 can be the anchor SB. In some aspects, the anchor SB can be the SB containing PDCCH candidates for single-CC PDCCH blind detection by a UE. For example, a UE can be configured to perform single-CC PDCCH blind detection on the anchor SB (e.g., SB0). In some aspects, the control channel (CCH) transmission 702 of FIG. 7A can be within the anchor sub-band SB0 730, and in some aspects can comprise or indicate PDCCH candidates, etc.

The non-contiguous BWP comprising BWP 705-1 and 705-2 can be used for the transmission (e.g., by the network entity) and reception (e.g., by the UE) of a single PDSCH or PUSCH that is scheduled by a single DCI. In some cases, the example virtual cell configuration 700 of FIG. 7A can correspond to a virtual cell for integrating bands with the same subcarrier spacing (SCS) and co-located deployment. In some examples, the single-TB scheduling associated with FIG. 7A can correspond to mapping a TB across the multiple SBs of the virtual cell (e.g., SB0 730, SB1 740, etc.) and/or non-contiguous activated BWP (e.g., comprising BWP 705-1 and 705-2, where BWP 705-1 is non-contiguous with BWP 705-2). The single TB mapping across the plurality of SBs can be performed using code-block (CB)-level interleaving. For example, a single TB can comprise a plurality of CBs, where each respective CB includes a plurality of coded bits arranged in a respective CB bit sequence.

In some examples, single TB mapping and single-TB scheduling corresponds to mapping the respective CBs included in the TB across the various SBs of the virtual cell. Mapping different CBs to different SBs can correspond to implementing a CB-level interleaving, where the CBs are interleaved to obtain an interleaved sequence of CBs that is different from the input sequence of CBs as included within the single TB. The CB bit sequence of the plurality of coded bits within each CB is not changed in examples where CB-level interleaving is performed. In some cases, the TB mapping across SBs with CB-level interleaving can be used in channel conditions and/or network environments with low-band spectrum with small channels, etc.

In some aspects, a TB spanning different SBs (e.g., multiple SBs of the virtual cell, where the multiple SBs comprise different and non-contiguous physical carrier, or components thereof, across different bands of the wireless network) can be scheduled with different link parameters, such as modulation order and rank. For example, SB0 730 may have channel conditions that support the use of quadrature amplitude modulation (QAM), such as 16QAM or other QAM modulation schemes, etc. SB1 740 may have different channel conditions that support the use of quadrature phase shift keying (QPSK) modulation, etc.

When SB0 730 and SB1 740 support and use the same link parameters (e.g., same modulation order, rank, same modulation scheme, etc.), CB-level interleaving can be performed by interleaving the modulated symbols generated for each CB. For example, CB-level interleaving can correspond to mapping each CB to one SB, where each SB is used to determine one or more modulated symbols. When SB0 740 and SB1 740 have different link parameters, modulation order, rank, and/or when SB0 730 and SB1 740 use different modulation schemes, CB-level interleaving cannot be performed by interleaving the modulated symbols determined for each sub-band.

In some examples, a virtual cell can be configured to implement FSI with multi-SB scheduling, for example using a multi-SB scheduling DCI (mSB DCI). FIG. 7B is a diagram illustrating an example of a virtual cell configuration 750 corresponding to multi-SB scheduling, in accordance with some examples. In some cases, the virtual cell configuration 750 of FIG. 7B can be associated with a virtual cell such as the virtual cell 640 of FIG. 6, etc.

In multi-SB scheduling, each TB is mapped onto a single SB of the virtual cell. For example, a first TB can be mapped to a first SB of the virtual cell, a second TB can be mapped to a second SB of the virtual cell, etc. In some aspects, the virtual cell associated with the multi-TB scheduling of FIG. 7B can be the same as the virtual cell configured with the single-TB scheduling of FIG. 7A (e.g., a virtual cell can be configured with multi-TB scheduling or single-TB scheduling). In some aspects, a multi-TB scheduling configuration (e.g., such as the multi-TB scheduling of FIG. 7B) can be used for virtual cells with relatively large per-SB bandwidths (e.g., wideband (WB) SBs or WB carriers provide the resources of the virtual cell, etc.).

For example, the virtual cell multi-TB scheduling configuration 750 of FIG. 7B can be implemented for a virtual cell that includes a lower band (e.g., lower SB) configured as an anchor SB for a CCH transmission 752. The first SB, SB0 732 of FIG. 7B can be the lower band anchor SB for the virtual cell multi-TB scheduling configuration 750, and can include the CCH transmission 752 that includes information indicative of scheduling for multiple TBs on different SBs of the virtual cell. The information indicative of the scheduling of TBs on SBs can also be referred to as a mapping, mapping information, or a mapping configuration.

In one illustrative example, the lower band anchor SB, SB0 732, can be used for a CCH transmission 752 comprising a single-CC PDCCH indicative of the scheduling information mapping multiple TBs on different SBs of the virtual cell. The CCH transmission 752 can be similar to the CCH transmission 702 of FIG. 7A. A UE can perform single-CC PDCCH blind detection to detect the CCH transmission 752 and obtain the scheduling information for mapping the multiple TBs on different SBs. In some cases, the single-CC PDCCH blind detection scheduling can be similar to MC-DCI scheduling, without requiring or configuring the UE to also support self-CC scheduling.

As noted above, the CCH transmission 752 can be a single-CC PDCCH that schedules multiple TBs on different SBs. For example, the CCH transmission 752 can include or indicate an mSB DCI that schedules a first PDSCH or PUSCH transmission 765-1 on (e.g., using) the first SB (e.g., SB₁), of the set of wideband carriers 770 within the virtual cell. The CCH transmission 752 can additionally include or indicate an mSB DCI that schedules a second PDSCH/PUSCH transmission on a second SB (e.g., SB₂) of the set of the wideband carriers 770, . . . , and an N^{th} PDSCH/PUSCH transmission 765-N on an N^{th} SB, (e.g., SB_{N}) of the set of wideband carriers 770.

In some aspects, the virtual cell multi-TB scheduling configuration 750 of FIG. 7B can be used for scheduling with large (e.g., wide) aggregated channel bandwidths (e.g., can be used for scheduling with virtual cells having large or relatively wide aggregated channel bandwidths across the SBs included within the virtual cell). For example, virtual cell multi-TB scheduling may be used where cross-SB diversity is not needed, as the mapping configuration of one TB per SB corresponds to a low cross-SB diversity (e.g., and the one TB scheduled across multiple SBs in the single-TB scheduling of FIG. 7A corresponds to a high cross-SB diversity).

The virtual cell multi-TB scheduling configuration 750 can be used for both intra-band and inter-band SBs that are configured within a virtual cell. In some aspects, based on the virtual cell (e.g., virtual carrier) being configured as a single HARQ entity to the network, frequency diversity can be achieved for the virtual cell multi-TB scheduling configuration 750 across HARQ transmissions.

In some cases, single-TB scheduling (e.g., such as the single-TB scheduling configuration 700 of FIG. 7A) can be performed for virtual cells where the SBs and/or frequency bands are co-located. Co-located SBs and frequency bands may refer to a co-located physical source of the RF signals corresponding to each SB or frequency band, and based on the physical co-location, the co-located SBs and frequency bands can have the same or highly similar link parameters, channel conditions, interference conditions, etc., on each SB of a plurality of co-located SBs configured within the virtual cell.

However, single-TB scheduling configurations can also be implemented for virtual cells where some, or all, of the SBs and frequency bands of the virtual cell are not co-located and/or where the SBs of the virtual cell are associated with different interference levels and loading on different bands. The non-co-located SBs and frequency bands may have different link parameters, channel conditions, interference conditions, etc. As noted above, for CA implementations, scheduling on each CC of the multiple aggregated CCs can be adapted independently from the remaining CCs, with the per-CC scheduling adaptation based on the particular or respective channel and/or interference conditions measured or determined for each CC. For FSI implementations that are not CA-based (e.g., with carrier aggregation being a type of FSI implementation), improvements associated with the non-CA-based aggregation of bandwidths and resources may be canceled out if the non-CA-based FSI implementation does not support per-CC or per-SB adaptation of link parameters (e.g., modulation and rank, etc.). In some examples, as also noted above, FSI implementations (e.g., such as virtual cell or virtual carrier-based aggregated bandwidths comprising a plurality of SBs) may support link adaptation only at the virtual cell level. In such examples, while channel and interference conditions may be measured on a per-CC or per-SB basis, link adaptation for the virtual cell is implemented as a uniform adaptation or adjustment applied to each CC or SB within the virtual cell.

For example, the virtual cell as a whole (e.g., each SB within the virtual cell) can be adjusted with a link adaptation that is determined using the highest quality SBs of the plurality of SBs within the virtual cell, in which case performance is decreased for the remaining SBs of the virtual cell with worse channel and/or interference conditions. In another example, the virtual cell as a whole (e.g., each SB within the virtual cell) can be adjusted with a link adaptation that is determined using the lowest quality SBs of the plurality of SBs within the virtual cell, in which case performance is decreased for the remaining SBs of the virtual cell with better (e.g., less severe) channel and/or interference conditions. In another example, the virtual cell as a whole (e.g., each SB within the virtual cell) can be adjusted with a link adaptation that is determined using an average calculated across the plurality of SBs, in which case performance is decreased by a first amount for a first subset of SBs with better than average channel conditions and interference conditions, and is decreased by a different, second amount for a second subset of SBs with worse than average channel and interference conditions.

In some aspects, single-TB FSI can be performed to increase or improve diversity, as interleaving the multiple CBs included within a single TB can be performed to distribute the CBs across a plurality of SBs based on the channel and/or interference conditions associated with each respective SB. For example, single-TB FSI can be performed using one or more interleavers that are configured to map each CB included in the single TB to different respective SBs that are associated with different channel and/or interference conditions. The mapping of the CBs of a single TB to different SBs that experience different conditions provides a diversity gain to the single-TB transmission and/or reception.

When the link parameters (e.g., such as QAM order or other modulation scheme order, modulation rank, etc.) are the same across the different SBs of a virtual cell, the link parameters are also the same for the different portions of a TB mapped to the different SBs of the virtual cell, and CB-level interleaving can be performed. For example, the CBs of a single TB can be mapped to different SBs based on a configured mapping scheme and the channel and/or interference conditions associated with each respective SB. From the mapping, each SB is associated with a subset of coded bits included in the bit sequence of the single TB (e.g., each SB is mapped to one or more CBs included in the single TB, and each CB comprises a CB bit sequence of a respective plurality of coded bits). The coded bits mapped to each SB can be interleaved using a block interleaver (e.g., rectangular interleaver) and corresponding modulated symbols can be generated for each SB. For example, the modulation scheme may be QAM, and the coded bits mapped to each SB in the interleaver performing CB-level interleaving can be used to generate one or more QAM symbols corresponding to the coded bits of the one or more CBs mapped to each SB. In some aspects, once the QAM symbols are generated, the QAM symbols can be interleaved (e.g., either with a unit of tone, an RB, a group of RBs (e.g., at a PRG bundling level, etc.) and mapped to the physical resources of the virtual cell or other aggregated bandwidth.

In examples where single-TB FSI (e.g., single-TB scheduling) is performed and the single TB is mapped to a plurality of SBs associated with different link parameters (e.g., different channel and/or interference conditions for some, or all, of the SBs of the plurality of SBs of a virtual cell, etc.), the generated QAM symbol bits can no longer be interleaved in the frequency domain. In some examples, the single TB can be mapped to a first SB that is associated with conditions and/or link parameters corresponding to QAM modulation, and a second SB that is associated with conditions and/or link parameters corresponding to QPSK modulation, and the QAM and QPSK symbols generated for the first and second SBs cannot be interleaved in the frequency domain at the CB-level.

In one illustrative example, the system and techniques can be used to perform interleaving at a bit-level of the plurality of coded bits included within the CB bit sequence for each CB included in a TB scheduled for transmission. For example, a first subset of coded bits can be determined as mapped to a first SB of a virtual cell or other aggregated bandwidth, a second subset of coded bits can be determined as mapped to a second SB of the virtual cell or other aggregated bandwidth, etc. After using the configured mapping or mapping scheme to determine the respective subset of the plurality of coded bits that is mapped to each respective SB of the plurality of SBs with different link parameters, the mapped subsets of bits for the individual SBs can be used to generate corresponding QAM symbols and mapped across layers according to the QAM order and rank associated with each of the SBs within the virtual cell.

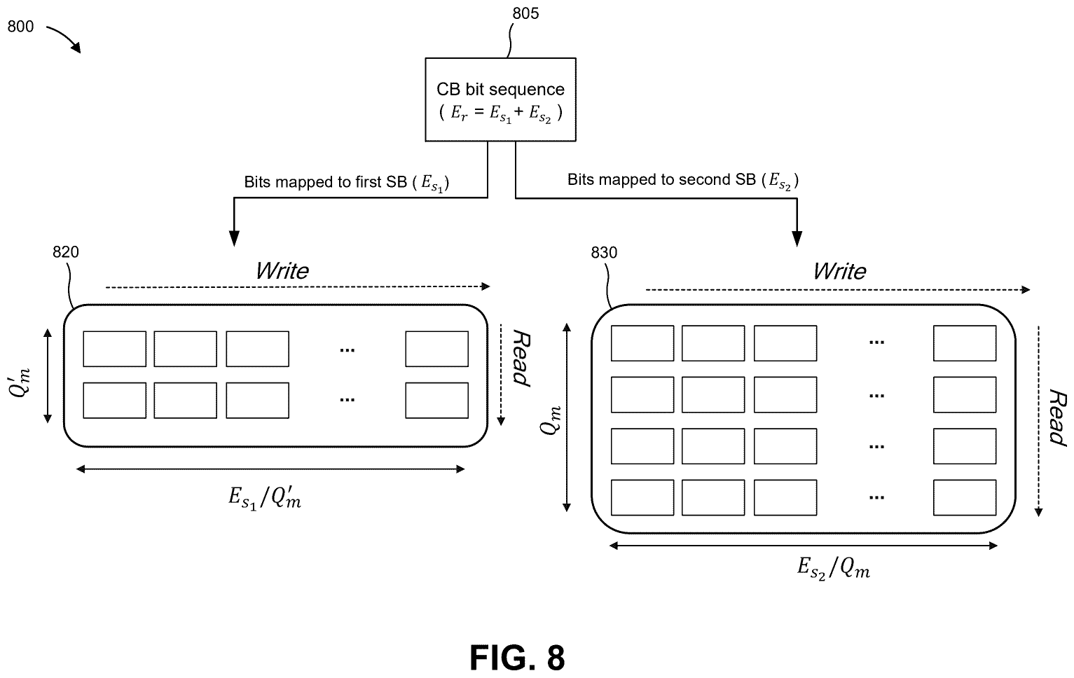

FIG. 8 is a diagram illustrating an example of per-subband (per-SB) bit interleaving 800, which can be performed for a code block (CB) bit sequence based on a mapping between the coded bits and a set of sub-bands (SBs) included within or configured for an aggregated bandwidth (e.g., an FSI aggregated bandwidth, such as a virtual carrier or virtual cell aggregated bandwidth, a CA aggregated bandwidth, etc.). The respective coded bits (e.g., from the CB bit sequence) mapped to each SB are interleaved using a corresponding block interleaver for the SB, in accordance with some examples.

For example, a CB bit sequence 805 can comprise a sequential order of a plurality of coded bits of a CB. The CB can be included within a single TB. The CB can correspond to a scheduled TB transmission. In some aspects, the CB bit sequence 805 can be represented as the bit sequence Eᵣ. A configured mapping and/or mapping scheme can be used to map each SB of a plurality of SBs to a respective subset of the plurality of coded bits within the CB bit sequence Eᵣ 805. The plurality of SBs can be a plurality of SBs associated with a virtual carrier or virtual cell (e.g., such as the SBs SB0-SB3 of the virtual cell 640 of FIG. 6, etc.), and/or the plurality of SBs can be a plurality of CCs associated with an aggregated CA bandwidth (e.g., such as the CCs CC0-CC3 of the aggregated CA bandwidth 620 of FIG. 6, etc.). In some examples, the plurality of SBs can include or correspond to the SBs SB₀ 730 and SB₁ 740 of the virtual carrier configuration 700 of FIG. 7A, and/or the SBs SB₀, SB₁, SB₂ of the virtual carrier configuration 750 of FIG. 7B, etc.

As noted above, the plurality of coded bits of the CB bit sequence Eᵣ 805 can be mapped to respective SBs of the plurality of SBs of the virtual cell or aggregated bandwidth. For example, the CB bit sequence 805 can be represented as Eᵣ=Eₛ_{₁}+Eₛ_{₂}, where Eᵣ represents the CB bit sequence 805 (e.g., the full plurality of coded bits of a CB), Eₛ_{₁} represents a first subset of the CB bit sequence 805 where the first subset Eₛ_{₁} is mapped to a first SB of the virtual cell, and Eₛ_{₂} represents a second subset of the CB bit sequence 805 where the second subset Eₛ_{₂} is mapped to a second SB of the virtual cell.

In one illustrative example, the systems and techniques can be configured to use information indicative of a mapping between an input CB bit sequence and a plurality of SBs, where the mapping is applied to a particular CB bit sequence (e.g., the CB bit sequence 805) to map each SB of the plurality of SBs to a respective subset of the plurality of coded bits included in the particular CB bit sequence. In some aspects, the subset of coded bits mapped to each SB according to the mapping can be provided to a corresponding block interleaver for the SB.

For example, each SB of the plurality of SBs of the virtual cell or aggregated bandwidth can be associated with a respective block interleaver configured to generate an interleaved CB bit sequence based on receiving as input the subset of coded bits from the particular CB bit sequence that are determined to be mapped to the particular SB associated with the particular block interleaver.

In some aspects, the coded bits mapped to the first SB based on the mapping (e.g., the first subset Eₛ_{₁} of the CB bit sequence Eᵣ 805) can be provided to a first block interleaver 820, where the first block interleaver 820 generates a first interleaved bit sequence based on performing interleaving of or for the first subset Eₛ_{₁} of the CB bit sequence Eᵣ 805. The coded bits mapped to the second SB according to the mapping information (e.g., the second subset Eₛ_{₂} of the CB bit sequence Eᵣ 805) can be provided to a second block interleaver 830, where the second block interleaver 830 generates a second interleaved bit sequence based on performing interleaving of or for the second subset Eₛ_{₂} of the CB bit sequence Eᵣ 805.

In one illustrative example, the per-SB bit interleaving corresponding to the example configuration 800 of FIG. 8 can be performed using Systematic Bit Priority Mapping (SBPM). For example, each block interleaver corresponding to a particular SB of the plurality of SBs (e.g., each of the block interleavers 820, 830 corresponding to the first and second SBs, respectively) can be implemented as SBPM interleavers, where an input bit sequence is written in a priority order from the top left of the interleaver (e.g., corresponding to a highest priority bit), horizontally across rows until ending at the bottom right of the interleaver (e.g., corresponding to a lowest priority bit). The input bits are written to the block (e.g., rectangular) interleavers 820, 830 horizontally by row, and interleaved bits are read from the block interleavers 820, 830 vertically by column to obtain the interleaved bits for generating modulated symbols. For example, each column of the block interleavers 820, 830 can correspond to a respective modulated symbol generated from the subset of bits mapped to the corresponding SB of the interleaver.

In some examples, the block interleavers 820, 830 can be configured as SBPM interleavers, where systematic bits (e.g., information carrying bits) are placed into the MSBs of the modulated symbols that are read out column-wise from the block interleavers 820, 830 for the first and second SBs, respectively.

The size or dimension of each block interleavers 820, 830 can be based on the modulation order of the bit sequence provided as input to the block interleaver. For example, the first block interleaver 820 receives the first subset Eₛ_{₁} of the CB bit sequence Eᵣ 805. The first subset of bits Eₛ_{₁} are mapped to a first SB of the virtual cell or aggregated bandwidth, and the first block interleaver 820 performs interleaving to generate modulated symbols for the first subset of bits Eₛ_{₁} mapped to the first SB. The first block interleaver 820 can have a vertical dimension (e.g., number of rows) represented as Q′ₘ, which is the modulation order of the first subset of bits Eₛ_{₁}. In some aspects, the term Q′ₘ can correspond to or represent the modulation order associated with the first SB, where the modulation order Q′ₘ of the first SB is based at least in part on the link parameters, channel conditions, and/or interference conditions associated with the first SB. The first block interleaver 820 can have a horizontal dimension (e.g., number of columns) represented as Eₛ_{₁}/Q′ₘ.

The second block interleaver 830 receives the second subset Eₛ_{₂} of the CB bit sequence Eᵣ 805. The second subset of bits Eₛ_{₂} are mapped to a second SB of the virtual cell or aggregated bandwidth, and the second block interleaver 830 performs interleaving to generate modulated symbols for the second subset of bits Eₛ_{₂} mapped to the second SB. The second block interleaver 830 can have a vertical dimension (e.g., number of rows) represented as Qₘ, which is the modulation order of the second subset of bits Eₛ_{₂}. In some aspects, the term Qₘ can correspond to or represent the modulation order associated with the second SB, where the modulation order Qₘ of the second SB is based at least in part on the link parameters, channel conditions, and/or interference conditions associated with the second SB. The second block interleaver 830 can have a horizontal dimension (e.g., number of columns) represented as Eₛ_{₂}/Qₘ.

The example configuration 800 of FIG. 8 can be referred to as per-SB interleaving or per-SB SBPM, where the subset of coded bits mapped to each SB of the virtual cell is interleaved using a separate block interleaver. The number of block interleavers can be equal to the number of SBs used for mapping the plurality of coded bits of the CB bit sequence 805. The number of block interleavers can be equal to the number of SBs included within the virtual cell (e.g., which can be the same as the number of SBs used for the mapping of the coded bits for the CB bit sequence 805).

In some aspects, the corresponding separate block interleaver configured for each SB and each mapped subset of coded bits from the input CB bit sequence 805 can have dimensions that are sized based on the modulation order for the particular SB (e.g., based on link parameters, channel and/or interference conditions of the SB, etc.) and the number of mapped bits for the particular SB. Different SBs can have different modulations, modulation order, rank, link parameters, channel conditions, interference conditions, etc. Link adaptation can be implemented based on adjusting the mapping of different bits from the input CB bit sequence 805 to the respective subsets of bits Eₛ_{₁} and Eₛ_{₂} that are interleaved by separate block interleavers each using a per-SB configuration and dimension or sizing. The particular mapping determination where respective bits from the input CB bit sequence 805 are mapped to the respective subsets of bits Eₛ_{₁} and Eₛ_{₂} for the respective SBs of the virtual cell or aggregated bandwidth can be based on a configured mapping that is signaled between a network entity (e.g., base station, gNB, etc.) and a UE.

In some cases, different SBs can correspond to different modulation schemes, and different per-SB block interleavers can be used to generate different types of modulated symbols for the subsets of bits mapped to each SB from the input CB bit sequence 805. For example, the first block interleaver 820 may be configured to generate QPSK modulated symbols for the first subset of coded bits Eₛ_{₁} of the input CB bit sequence 805, and the second block interleaver 830 may be configured to generate 16QAM modulated symbols for the second subset of coded bits Eₛ_{₂} of the input CB bit sequence 805, etc.

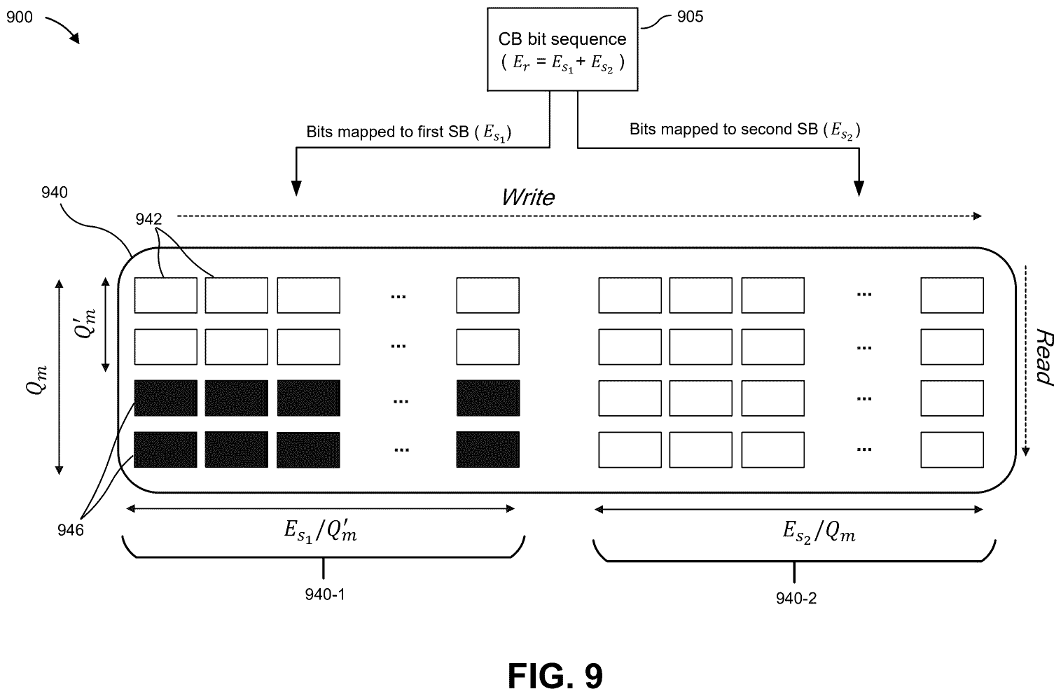

In another illustrative example, the systems and techniques can be configured to implement single SBPM, based on performing combined interleaving across the plurality of SBs of the virtual cell or aggregated bandwidth. The combined interleaving and/or single SBPM can also be referred to as group interleaving, joint interleaving, etc., for the plurality of SBs and/or the input CB bit sequence of a plurality of coded bits. For example, FIG. 9 is a diagram illustrating an example of combined bit interleaving 900 for a CB bit sequence 905, based on a mapping between the coded bits and a set of SBs, where the bits mapped to each SB are interleaved using different portions and/or different configurations of a single block interleaver for all SBs, in accordance with some examples.

The CB bit sequence 905 of FIG. 9 can be the same as or similar to the CB bit sequence 805 of FIG. 8, and the CB bit sequence 905 can be represented as the bit sequence Eᵣ=Eₛ_{₁}+Eₛ_{₂}. The combined bit interleaving configuration 900 can be performed using a single block (e.g., rectangular interleaver 940), with a size or dimension of the single block interleaver 940 for combined interleaving being based at least in part on a largest modulation order of an SB within the plurality of SBs of the virtual cell or aggregated bandwidth.

For example, a first and second SB associated with the combined interleaving scheme 900 of FIG. 9 can be the same as the first and second SB associated with the per-SB interleaving scheme 800 of FIG. 8. The first SB and corresponding first subset of coded bits Eₛ_{₁} mapped to the first SB can have a modulation order that corresponds to using Q′ₘ rows of the block interleaver 940 to generate the corresponding interleaved bits and modulated symbols for the first SB. For example, the first SB and corresponding first subset of coded bits Eₛ_{₁} mapped to the first SB in the example of FIG. 9 can use the same number of rows Q′ₘ and the same number of columns

$${E}_{{s}_{1}} / {Q}_{m}^{′}$$

to interleave the first subset of coded bits Eₛ_{₁} and generate the first subset of modulated symbols from the interleaver columns.

In the per-SB interleaving scheme 800 of FIG. 8, the Q′ₘ interleaver rows and the

$${E}_{{s}_{1}} / {Q}_{m}^{′}$$

interleaver columns used for interleaving the first subset of coded bits Eₛ_{₁} mapped to the first SB were configured within a corresponding separate interleaver provided for the first SB of the virtual cell or aggregated bandwidth (e.g., first block interleaver 820 of FIG. 8).

In the combined interleaving scheme 900 of FIG. 9, the first subset of coded bits Eₛ_{₁} that are mapped to the first SB can be interleaved using a portion 940-1 of the larger, single block interleaver 940 that includes the same quantities of the Q′ₘ interleaver rows and the

$${E}_{{s}_{1}} / {Q}_{m}^{′}$$

interleaver columns for the first SB as are included in the dedicated, per-SB block interleaver 820 of FIG. 8.

The dimensions of the single, combined block interleaver 920 can be based on the SB with the largest modulation order. For example, the single, combined block interleaver 920 can include four rows, based on the largest modulation order of the plurality of SBs, which in this example is the modulation order associated with the second SB and the second subset of coded bits Eₛ_{₂}. To interleave the subsets of coded bits mapped to SBs with modulation orders that are smaller than the largest modulation order SB that is used to size the interleaver 940, the systems and techniques can be configured to deactivate, skip, and/or not use the entries of a portion of the single interleaver 940. For example, to interleave the first subset of coded bits Eₛ_{₂}, the corresponding portion 940-1 of the larger, single block interleaver 940 can comprise a number of rows Q′ₘ that is less than the total number of rows Qₘ included in the interleaver 940. The corresponding portion 940-1 of the larger, single block interleaver 940 can further comprise a number of columns

$${E}_{{s}_{1}} / {Q}_{m}^{′}$$

that is less than the total number of columns

$${E}_{{s}_{1}} / {Q}_{m}^{′} + {E}_{{s}_{2}} / {Q}_{m}$$

included in the interleaver 940.

To perform the interleaving of the CB bit sequence 905, the input CB bit sequence 905 can be mapped into the first and second subsets Eₛ_{₁} and Eₛ_{₂} determined based on the mapping information configured between the UE and the network entity. The first and second subsets Eₛ_{₁} and Eₛ_{₂} can be written to the single interleaver 940 row-wise, starting from the top left entry 942 within the first row, followed by the second from left entry 942 within the first row, . . . , followed by the second from right entry within the last row, and ending by the farthest right entry within the last row. For example, the first row of the single interleaver 940 can be written with the bits comprising the first row of the coded bits mapped to the first SB and first subset Eₛ_{₁}, followed by the bits comprising the first row of the coded bits mapped to the second SB and second subset Eₛ_{₂}. In the combined interleaving scheme 900 of FIG. 9, one or more rows of the single interleaver 940 are written with the coded bits mapped to the respective subsets corresponding to each SB of the plurality of SBs within the virtual cell or aggregated bandwidth.

One or more rows of the single interleaver 940 are configured with unavailable entries 946, for the rows of the single interleaver 940 that are outside of the smaller number of rows used for SBs that do not have the largest modulation order out of the plurality of SBs. For example, the portion 940-1 of the interleaver 940 that is used for the first SB and first subset of bits Eₛ_{₁} can configure the interleaver entries 946 in the rows beyond Q′ₘ and the columns within the range

$${E}_{{s}_{1}} / {Q}_{m}^{′}$$

as unavailable, deactivated, or to be skipped during the row-wise write operations to populate the single interleaver 940 with the input bits from the CB bit sequence 905. The portion 940-2 of the single interleaver 940 that is configured for interleaving the subset of bits associated with the largest modulation order SB can be fully utilized (e.g., does not include any unavailable interleaver entries 946). For example, the portion 940-2 of the single interleaver 940 used for interleaving the second subset of bits Eₛ_{₁} can include the interleaver entries for each of the Qₘ interleaver rows of the single interleaver 940 that are within the range of columns

$${E}_{{s}_{2}} / {Q}_{m}^{′} .$$

In some aspects, information indicative of a mapping between an input CB bit sequence and a plurality of SBs of a virtual cell or other aggregated bandwidth can be signaled between a network entity and a UE, and used to determine the mapping of respective subsets of bits from a particular CB bit sequence to respective SBs of the plurality of SBs. The information and/or mapping can be indicative of a particular bit-to-SB mapping scheme or mapping approach, for example selected between the per-SB interleaving of FIG. 8 and the single, combined interleaving across all SBs of FIG. 9. In some aspects, per-SB interleaving schemes and combined interleaving schemes can be implemented to map some (or all) of the systematic, information-bearing bits of a particular CB bit sequence being interleaved (e.g., associated with a scheduled TB transmission, etc.) to different SBs, and can be implemented to map some (or all) of the parity, error-check or error-correcting bits for the particular CB bit sequence to different SBs.

The systematic bits and parity bits mapped to different SBs can experience different channel conditions and/or interference conditions, based on the particular SB to which a particular systematic or parity bit is mapped. In some cases, the systematic and parity bits of the CB bit sequence can be mapped to different modulation symbols with different QAM orders. In some examples, the systematic and parity bits of the CB bit sequence can be mapped to different bit positions (e.g., different configured bit positions) within the m-tuples mapped to 2^{m} QAM, where MSBs are better protected than the LSBs.

In some aspects, the information indicative of the mapping can be used to implement, for a UE and a network entity performing communications using a plurality of SBs or CCs of a virtual cell or other aggregated bandwidth, a mapping scheme to distribute the CB bit sequences across the available resources to improve performance.

For example, the mapping information can be indicative of a determined mapping scheme that is based on one or more factors, including channel conditions experienced by different SBs and/or interference conditions experienced by different SBs. The channel condition and/or interference condition information can be signaled as absolute valued information, relative valued information or relative order information, or various combinations thereof. The mapping information can be indicative of a determined mapping scheme that is based at least in part on the particular frequency bands in which an SB is located, link parameter such as QAM orders and rank selected for each SB, redundancy version, coding rate, etc.

In one illustrative example, the order of the mapping of a CB bit sequence to the resources scheduled and/or configured for downlink transmission and/or uplink transmission across different carriers (e.g., CCs for an aggregated bandwidth associated with CA), or across different SBs of a virtual carrier or cell (e.g., SBs for a virtual carrier or virtual cell for FSI) can be signaled between a network entity and a UE. In some cases, the determination can be performed by the network entity (e.g., base station, gNB, etc.) based on channel and interference conditions across the SBs, the relative channel and interference conditions across SBs, link parameters for each SB (e.g., such as QAM order and rank selected for different SBs), RV index, coding rate of the TB, initial transmission and re-transmission, UE capabilities and/or UE capability information signaled from the UE to the network entity, etc.

In some aspects, the determination of the information indicative of the configured mapping or mapping scheme can be performed by a network entity, based on receiving a request from a UE. For example, the UE may measure channel conditions with greater accuracy than the network entity, and the UE can determine a desired mapping or mapping scheme to be used for the CB bit-level interleaving for scheduled TB transmissions between the UE and the network entity. The UE can transmit a request to the network entity to use the mapping determined by the UE, and the network entity may accept the request and transmit to the UE information indicative of permission to use the requested mapping determined by the UE. The network entity may also not accept the request and can transmit to the UE information indicative of denied permission to use the requested mapping determined by the UE and/or can transmit information indicative of a different mapping than the requested mapping determined by the UE.

In some cases, the systems and techniques can implement CB bit mapping to SBs of a virtual cell or other aggregated bandwidth using a multi-level determination configured between the UE and network entity. For example, a first level of the CB bit mapping determination can correspond to a selection or indication of how to perform SBPM or other interleaving across the plurality of SBs or CCs. For example, the information indicative of the mapping can indicative a selection between per-SB SBPM or interleaving (e.g., such as the per-SB interleaving configuration 800 of FIG. 8) and combined SBPM or interleaving across all of the plurality of SBs (e.g., such as the combined or joint SB interleaving configuration 900 of FIG. 9). In examples where the plurality of SBs includes more than two SBs, in some cases the information indicative of the mapping can indicate a configuration where SBPM or interleaving is performed jointly across a first group of SBs (e.g., using the single interleaver 940 of FIG. 9) and is performed separately across a second group of SBs (e.g., using a per-SB interleaver 820, 830 for the bits mapped to each SB within the second group of SBs).

A second level of the CB bit mapping determination can correspond to a selection or indication of the order of mapping bits from the input CB bit sequence to different SBs of the plurality of SBs within the virtual cell or other aggregated bandwidth. For example, the information indicative of the mapping can indicate a starting point of the mapping, where the starting point comprises a configured bit position. In some cases, the starting point of the mapping can be the starting bit of the input CB bit sequence, or can be a different bit position that is not the starting bit of the input CB bit sequence (e.g., an intermediate bit position within the CB bit sequence).

In some cases, the mapping can map sets of consecutive bits within the input CB bit sequence to different SBs. In some examples, the mapping can be based on selecting non-consecutive bits from the input CB bit sequence for mapping to the respective SBs. For example, a first bit of the CB bit sequence can be mapped to a first SB, the second bit of the CB bit sequence can be mapped to a second SB, a third bit of the CB bit sequence can be mapped to a third SB, . . . , etc.). In some cases, the mapping can be indicated in an order or sequence of SB bit indices (e.g., bits are mapped in order of SB0, SB1, SB2, SB3, . . . , SB_{N}, before circling back to return to SB0, SB1, . . . , for the next row of the interleaver. In some aspects, the mapping can be indicated using a non-consecutive order or sequence of the SB bit indices. In some aspects, the mapping can be based on selectin and/or assigning (e.g., mapping)O a first portion of the systematic bits of the CB bit sequence to a first SB and mapping a first portion of the parity bits for the CB bit sequence to the first SB. A second portion of the systematic bits can be mapped to a second SB, and a second portion of the parity bits can be mapped to the second SB, . . . etc.

In some aspects, the determination of the mapping scheme (e.g., determination of the mapping and/or information indicative of the mapping) can be performed by a network entity (e.g., base station, gNB, etc.) and subsequently signaled from the network entity to the UE. In other examples, the UE can transmit a request to the network entity indicative of a request for selection of a particular mapping or mapping scheme, as noted previously above. In some cases, the mapping scheme can be the same for DL and UL transmission between the UE and the network entity using the virtual cell or aggregated bandwidth for FSI. In other examples, a first mapping scheme can be used for DL transmissions and a second mapping scheme can be used for UL transmissions, where the first and second mapping schemes are different. In some cases, the type of mapping indicated can be based at least in part on one or more capabilities of the UE. For example, the UE can signal UE capability information to the network entity, and the network entity can determine the selected or configured mapping for CB bit-level interleaving for TB transmission based at least in part on the received UE capability information. In some cases, the UE can signal UE capability information indicative of the particular mapping schemes that are supported by the UE (e.g., per-SB interleaving, combined interleaving across all SBs, contiguous or non-contiguous bit selection or mapping, etc.). In some cases, the UE can signal UE capability information corresponding to block interleavers that are included within, configured for, or that can be configured or implemented by the UE. For example, the UE can signal UE capability information and the network entity can determine the support and/or unsupported interleaving and mapping schemes for the UE, based on the received UE capability information.

In some cases, the information indicative of the mapping between CB bit sequences and a plurality of SBs of a virtual cell or aggregated bandwidth can be signaled from the network entity to the UE using one or more of RRC signaling, MAC-CE signaling, and/or dynamic signaling using PDCCH. In some aspects, the determination can be based at least in part on the DCI format, RNTI, search space type (CSS or UESS, etc.), whether a TB is scheduled as unicast, groupcast, multicast, or broadcast, etc., the CORESET configured or utilized, etc. For example, if a TB is scheduled by SI-RNTI, P-RNTI, RA-RNTI, TC-RNTI, etc., a fallback or default mapping scheme option can be configured or assumed between the UE and the network entity. For example, TBs scheduled by SI-RNTI, P-RNTI, RA-RNTI, TC-RNTI, etc., may be unable to be mapped by the UE to multiple SBs, and the fallback or default configuration of per-SB mapping (e.g., as in the per-SB configuration 800 of FIG. 8) can be used and assumed by default between the UE and network entity.

In some cases, the type of mapping may be based at least in part on the CCs and/or SBs on which a TB is scheduled or configured for transmission and/or reception between the network entity and the UE. For example, a virtual carrier can include the plurality of SBs SB0-SB3. The information indicative of the mapping can indicate a configuration where a scheduled TB using SB0-SB1 will utilize a first mapping information or a first mapping configuration, and a scheduled TB using SB2-SB3 will utilize a second mapping information or a second mapping configuration different from the first. In some examples, the scheduled TB using SB0-SB1 may use the per-SB mapping and interleaving configuration 800 of FIG. 8, and the scheduled TB using SB2-SB3 may use the combined mapping and interleaving configuration 900 of FIG. 9, etc. In some examples, before a UE signals corresponding UE capability information to the network, the UE may establish initial access to a virtual carrier including a plurality of SBs. For TB transmission prior to signaling UE capability information to the network entity, the scheduled TB transmission can by default be configured for mapping to multiple SBs, with a mapping scheme or mapping configuration that is fixed (e.g., pre-determined, hard-coded, static, indicated according to the wireless network specification, etc.). In some cases, a configured mapping type for scheduled TBs prior to signaling UE capability information may be signaled from the network entity to the UE via MIB or PBCH.

After performing bit selection and mapping according to the signaled information between the network entity and the UE that is indicative of the mapping, QAM symbols can be generated and resource allocation (e.g., frequency domain resource allocation (FDRA)) can be performed within each SB of the plurality of SBs. In some cases, the resource allocation type (e.g., type 0, type 1, corresponding to interleaved or non-interleaved, respectively, from NR) across SBs of the plurality of SBs may be the same, or may be signaled to be different. In some cases, dynamic resource allocation type switching can be applied to all SBs, or can be indicated separately. In some cases, each of the resource allocation types can be applied to each SB of the plurality of SBs independently, on a per-SB basis. In other examples, each of the resource allocation types can be applied over the resources available in multiple SBs. In some cases, RB indexing for FDRA can be performed per-SB, or can be performed taking all RBs within a group of SBs jointly. In some examples, SBs can be restricted to have been scheduled or configured with the same link parameters (e.g., such as QAM order and/or rank), and/or the same numerology, etc.

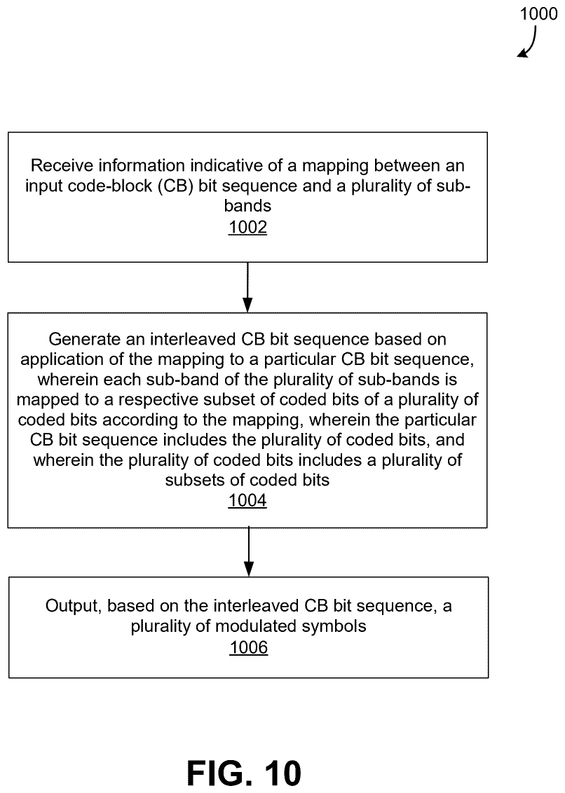

FIG. 10 is a flowchart diagram illustrating an example of a process 1000 for wireless communication. The process 1000 may be performed by a network entity or network device (or apparatus) or a component (e.g., a chipset, codec, etc.) of the network entity or device. The network entity may be a ULE (e.g., the UE 104 of FIG. 1, FIG. 2, and/or FIG. 3, the wireless device 407 of FIG. 4, or other UE). The network entity (e.g., UE) can be a mobile device (e.g., a mobile phone), a network-connected wearable such as a watch, an extended reality (XR) device (e.g., a virtual reality (VR) device or augmented reality (AR) device), a vehicle or component or system of a vehicle, or other type of computing device configured to perform wireless communications. The operations of the process 1000 may be implemented as software components that are executed and run on one or more processors (e.g., the transmit processor 264, the receive processor 258, the TX MIMO processor 266, the MIMO detector 256 of FIG. 2, the processing system 470 of FIG. 4, the processor(s) 484 of FIG. 4, the processing system 1202 of FIG. 12, and/or the processor 1210 of FIG. 12, or other processor(s) (e.g., such as one or more other processors included within and/or associated with the processing system 470 of FIG. 4, the processing system 1202 of FIG. 12, etc.)). Further, the transmission and reception of signals by the network entity in the process 1000 may be enabled, for example, by one or more antennas, one or more transceivers (e.g., wireless transceiver(s)), and/or other communication components (e.g., the transmit processor 264, the receive processor 258, the TX MIMO processor 266, the MIMO detector 256, the modulator(s)/demodulator(s) 254a through 254t, and/or the antenna(es) 252a through 252t of FIG. 2, the antenna(es) 487 of FIG. 4, the wireless transceiver(s) 478 of FIG. 4, the communication interface 1240 of FIG. 12, or other antennae(s), transceiver(s), and/or component(s)).

At block 1002, the network entity (or component thereof) can receive information indicative of a mapping between an input code-block (CB) bit sequence and a plurality of sub-bands.

For example, the mapping can be based on capability information corresponding to one or more interleavers of a processing system included in the network entity. The one or more interleavers can be used to generate an interleaved CB bit sequence based on application of the mapping to a particular CB bit sequence. In some cases, to receive the information, the processing system is configured to receive signaling including the information, wherein the signaling includes radio resource control (RRC) signaling or media access control (MAC)-control element (MAC-CE) signaling. In some examples, to receive the information, the processing system is configured to receive a physical downlink control channel (PDCCH) transmission including the information.

In some examples, the network entity is a user equipment (UE), such as the ULE 104 of FIG. 6. In some cases, to receive the information indicative of the mapping, the processing system is configured to receive the information from a second network entity. For example, the information indicative of the mapping can be received by the UE 104 of FIG. 6 from the network entity 102 of FIG. 6, etc.

In some cases, an aggregated bandwidth includes the plurality of sub-bands, and a scheduled transmission of a transport block (TB) corresponds to the particular CB bit sequence. For example, the TB can include the plurality of modulated symbols. In some examples, the plurality of sub-bands comprises a plurality of component carriers associated with carrier aggregation by the network entity. For example, the plurality of sub-bands can be the same as or similar to the plurality of component carriers CC0-CC3 included in the carrier aggregation aggregated bandwidth 620 of FIG. 6. In some cases, the plurality of sub-bands is associated with a virtual carrier configured for flexible spectrum integration (FSI). For example, the plurality of sub-bands can be associated with the virtual carrier aggregated bandwidth 640 of FIG. 6, etc.

At block 1004, the network entity (or component thereof) can generate an interleaved CB bit sequence based on application of the mapping to a particular CB bit sequence, wherein each sub-band of the plurality of sub-bands is mapped to a respective subset of coded bits of a plurality of coded bits according to the mapping, wherein the particular CB bit sequence includes the plurality of coded bits, and wherein the plurality of coded bits includes a plurality of subsets of coded bits. For example, the interleaved CB bit sequence can be generated based on using the interleavers 820 and/or 840 of FIG. 8 to apply the mapping to the CB bit sequence 805 of FIG. 8. In some cases, the interleaved CB bit sequence can be generated based on using the interleaver 920 of FIG. 9 to apply the mapping to the CB bit sequence 905 of FIG. 9, etc.

In some examples, to generate the interleaved CB bit sequence, the processing system is configured to process the plurality of coded bits using a plurality of interleavers, wherein each interleaver of the plurality of interleavers corresponds to a respective sub-band of the plurality of sub-bands. For example, the interleaver 820 of FIG. 8 corresponds to a first sub-band of a plurality of sub-bands associated with the CB bit sequence 805 and/or the mapping, and the interleaver 840 of FIG. 8 corresponds to a second sub-band of the plurality of sub-bands associated with the CB bit sequence 805 and/or the mapping. In some cases, to process the plurality of coded bits using the plurality of interleavers, the processing system is configured to process each subset of coded bits of the plurality of subsets of coded bits using a respective interleaver of the plurality of interleavers.

In some examples, a quantity of interleavers included in the plurality of interleavers is the same as a quantity of sub-bands included in the plurality of sub-bands. In some cases, to generate the interleaved CB bit sequence, the processing system is configured to process each subset of coded bits of the plurality of subsets of coded bits using a single interleaver. For example, to generate the interleaved CB bit sequence, the processing system can process each subset of coded bits of the plurality of subsets of coded bits of the input CB bit sequence 905 of FIG. 9 using the single interleaver 920 of FIG. 9, etc. In some cases, the processing system is configured to process each subset of coded bits of the plurality of subsets of coded bits using a portion of a single interleaver.

In some examples, to generate the interleaved CB bit sequence, the processing system is configured to determine, based on the mapping, each respective subset of coded bits of the plurality of subsets of coded bits mapped to each sub-band of the plurality of sub-bands. The processing system can cause each respective subset of coded bits of the plurality of subsets of coded bits to be processed by one or more interleavers of the processing system.

In some cases, the mapping is between the input CB bit sequence and a plurality of columns corresponding to one or more interleavers of the processing system, wherein each sub-band of the plurality of sub-bands corresponds to a respective subset of one or more columns of the plurality of columns. For example, the one or more interleavers can be the same as or similar to the interleavers 820 and/or 830 of FIG. 8, and/or the interleaver 940 of FIG. 9, etc.

In some cases, the information includes an indication of a starting bit position for the mapping within one or more of the input CB bit sequence or the particular CB bit sequence. For example, the information can be indicative of a starting bit position for the mapping within the CB bit sequence 805 of FIGS. 8 and/or 905 of FIG. 9. In some cases, each subset of coded bits of the plurality of subsets of coded bits includes consecutive bits within the input CB bit sequence based on the mapping. In some cases, the mapping is between respective bit positions within the input CB bit sequence and respective sub-band indices associated with the plurality of sub-bands.

In some examples, according to the mapping, each subset of coded bits of the plurality of subsets of coded bits includes: a respective set of one or more systematic bits of the particular CB bit sequence, and a respective set of one or more parity bits of the input CB bit sequence. For example, the CB bit sequence 805 of FIGS. 8 and/or 905 of FIG. 8 can include the respective sets of one or more systematic bits and the respective sets of one or more parity bits.

In some cases, the mapping is based on link quality information corresponding to the plurality of sub-bands. In some examples, the link quality information comprises one or more of: channel condition information corresponding to the plurality of sub-bands, or interference information corresponding to the plurality of sub-bands. In some cases, the mapping is based on one or more of: a respective modulation order for each sub-band of the plurality of sub-bands, or a respective rank configured for each sub-band of the plurality of sub-bands. In some examples, the processing system is configured to determine the link quality information.

In some cases, to generate the interleaved CB bit sequence, the processing system is configured to process the plurality of coded bits using one or more interleavers, wherein each interleaver of the one or more interleavers corresponds to a respective subset of sub-bands of the plurality of sub-bands. For example, a first interleaver can correspond to a first subset of sub-bands, where the first subset of sub-bands includes one or more sub-bands of the plurality of sub-bands. In some cases, the first subset of sub-bands includes multiple sub-bands of the plurality of sub-bands (e.g., includes two or more sub-bands of the plurality of sub-bands, etc.). A second interleaver can correspond to a second subset of sub-bands, where the second subset of sub-bands includes one or more sub-bands of the plurality of sub-bands. In some examples, the second subset of sub-bands includes multiple sub-bands of the plurality of sub-bands (e.g., includes two or more sub-bands of the plurality of sub-bands, etc.). In some cases, the first subset of sub-bands can be different from the second subset of sub-bands. For example, the respective subset of coded bits mapped to each sub-band of the plurality of sub-bands can be processed by a respective interleaver selected from the one or more interleavers, based on the mapping between the one or more interleavers and the respective subset of sub-bands.

In some examples, a quantity of interleavers included in the one or more interleavers is less than a quantity of sub-bands included in the plurality of sub-bands. For example, the quantity of interleavers included in the one or more interleavers can be less than the quantity of sub-bands included in the plurality of sub-bands, and can be greater than one (e.g., the one or more interleavers can comprise two or more interleavers, etc.). In some examples, the quantity of interleavers included in the one or more interleavers can be less than the quantity of sub-bands included in the plurality of sub-bands, and can be greater than or equal to one (e.g., the one or more interleavers can comprise at least one interleaver, etc.).

In some cases, to process the plurality of coded bits using the one or more interleavers, the processing system can be configured to process a first portion of the plurality of coded bits using a first interleaver of the one or more interleavers. The first interleaver can correspond to a first subset of sub-bands of the plurality of sub-bands, and the first portion of the plurality of coded bits can include the respective subset of coded bits mapped to each sub-band of the first subset of sub-bands. The processing system can be configured to process a second portion of the plurality of coded bits using a second interleaver of the one or more interleavers. The second interleaver can correspond to a second subset of sub-bands of the plurality of sub-bands, and the second portion of the plurality of coded bits can include the respective subset of coded bits mapped to each sub-band of the second subset of sub-bands.

At block 1006, the network entity (or component thereof) can output, based on the interleaved CB bit sequence, a plurality of modulated symbols. In some cases, the plurality of sub-bands includes a first sub-band and a second sub-band, where the first sub-band is mapped to a first subset of coded bits of the plurality of subsets of coded bits of the plurality of coded bits according to the mapping, and where the second sub-band is mapped to a second subset of coded bits of the plurality of subsets of coded bits of the plurality of coded bits according to the mapping.

In some examples, the plurality of modulated symbols includes a first set of quadrature amplitude modulation (QAM) modulated symbols corresponding to the first subset of coded bits, and a second set of quadrature phase shift keying (QPSK) modulated symbols corresponding to the second subset of coded bits. For example, the plurality of modulated symbols generated based on an interleaved CB bit sequence corresponding to the CB bit sequence 805 of FIG. 8 can include a first set of QAM modulated symbols generated by interleaving the first subset of coded bits corresponding to the first sub-band, using the first interleaver 820 of FIG. 8. In some cases, the plurality of modulated symbols generated based on an interleaved CB bit sequence corresponding to the CB bit sequence 805 of FIG. 8 can include a second set of QPSK modulated symbols generated by interleaving the second subset of coded bits corresponding to the second sub-band, using the second interleaver 840 of FIG. 8.

In some cases, the mapping is indicative of a first modulation order for the first subset of coded bits and a second modulation order for the second subset of coded bits. In some examples, to generate the interleaved CB bit sequence, the processing system is configured to cause the first subset of coded bits to be processed by a first interleaver based on the first modulation order. In some cases, to generate the interleaved CB bit sequence, the processing system is configured to cause the second subset of coded bits to be processed by a second interleaver based on the second modulation order.

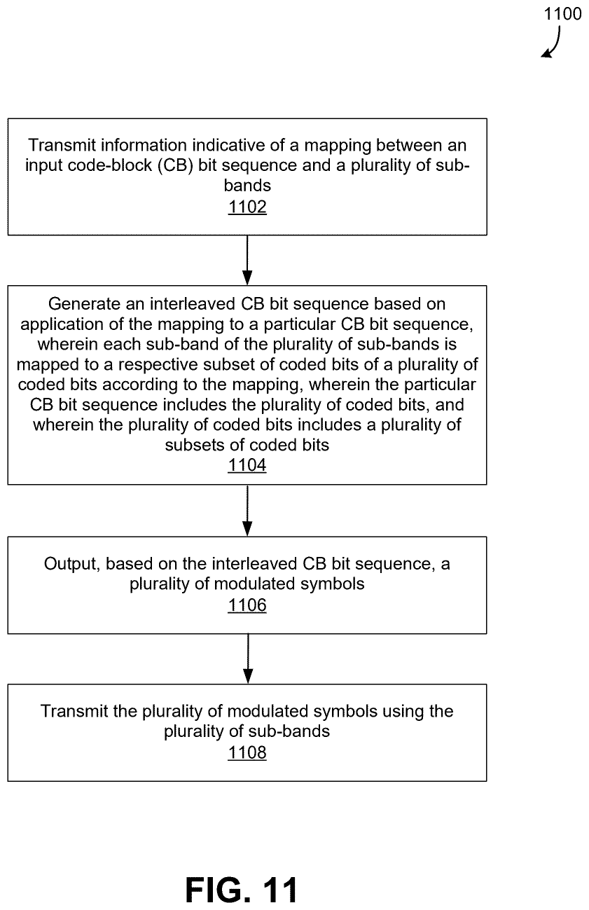

FIG. 11 is a flowchart diagram illustrating an example of a process 1100 for wireless communication. The process 1100 may be performed by a network entity or network device (or apparatus) or a component (e.g., a chipset, codec, etc.) of the network entity or device. The network entity may be a base station (e.g., an eNB, a gNB, etc.) or a portion of a base station (e.g., one or more of a CU, a DU, a RU, a Near-RT RIC, and/or a Non-RT RIC, such as the CU 310, the DU 330, the RU 340, the Near-RT RIC 325, and/or the Non-RT RIC 315 of the disaggregated base station 300 of FIG. 3), server device, or other network entity. The operations of the process 1100 may be implemented as software components that are executed and run on one or more processors (e.g., the transmit processor 220, the receive processor 238, the TX MIMO processor 230, the MIMO detector 236 of FIG. 2, the processing system 470 of FIG. 4, the processor(s) 484 of FIG. 4, the processing system 1202 of FIG. 12, and/or the processor 1210 of FIG. 12, or other processor(s) (e.g., such as one or more other processors included within and/or associated with the processing system 470 of FIG. 4, the processing system 1202 of FIG. 12, etc.)). Further, the transmission and reception of signals by the network entity in the process 1100 may be enabled, for example, by one or more antennas, one or more transceivers (e.g., wireless transceiver(s)), and/or other communication components (e.g., the transmit processor 220, the receive processor 238, the TX MIMO processor 230, the MIMO detector 236, the modulator(s)/demodulator(s) 232a through 232t, and/or the antenna(es) 234a through 234t of FIG. 2, the communication interface 1240 of FIG. 12, or other antennae(s), transceiver(s), and/or component(s)).

At block 1102, the network device (or component thereof) can transmit information indicative of a mapping between an input code-block (CB) bit sequence and a plurality of sub-bands. In some cases, the information indicative of the mapping can be the same as or similar to the information indicative of the mapping that is received at block 1102 of the process 1000 of FIG. 10, described above. For example, the mapping can be based on capability information corresponding to one or more interleavers of a processing system included in the network entity. The one or more interleavers can be used to generate an interleaved CB bit sequence based on application of the mapping to a particular CB bit sequence. In some cases, to transmit the information, the processing system is configured to transmit signaling including the information, wherein the signaling includes radio resource control (RRC) signaling or media access control (MAC)-control element (MAC-CE) signaling. In some examples, to transmit the information, the processing system is configured to transmit a physical downlink control channel (PDCCH) transmission including the information.

In some examples, the network entity is a base station or gNB, such as the base station 102 of FIG. 6. In some cases, to transmit the information indicative of the mapping, the processing system is configured to transmit the information to a second network entity (e.g., such as the UE 104 of FIG. 6). For example, the information indicative of the mapping can be transmitted from the base station 102 of FIG. 6 to the UE 104 of FIG. 6, etc. In some cases, an aggregated bandwidth includes the plurality of sub-bands, and a scheduled transmission of a transport block (TB) corresponds to the particular CB bit sequence. For example, the TB can include the plurality of modulated symbols. In some examples, the plurality of sub-bands comprises a plurality of component carriers associated with carrier aggregation by the network entity. For example, the plurality of sub-bands can be the same as or similar to the plurality of component carriers CC0-CC3 included in the carrier aggregation aggregated bandwidth 620 of FIG. 6. In some cases, the plurality of sub-bands is associated with a virtual carrier configured for flexible spectrum integration (FSI). For example, the plurality of sub-bands can be associated with the virtual carrier aggregated bandwidth 640 of FIG. 6, etc.

At block 1104, the network device (or component thereof) can generate an interleaved CB bit sequence based on application of the mapping to a particular CB bit sequence, wherein each sub-band of the plurality of sub-bands is mapped to a respective subset of coded bits of a plurality of coded bits according to the mapping, wherein the particular CB bit sequence includes the plurality of coded bits, and wherein the plurality of coded bits includes a plurality of subsets of coded bits. For example, the interleaved CB bit sequence can be generated based on using the interleavers 820 and/or 840 of FIG. 8 to apply the mapping to the CB bit sequence 805 of FIG. 8. In some cases, the interleaved CB bit sequence can be generated based on using the interleaver 920 of FIG. 9 to apply the mapping to the CB bit sequence 905 of FIG. 9, etc.

In some cases, the interleaved CB bit sequence generated at block 1104 of the process 1100 of FIG. 11 can be the same as or similar to the interleaved CB bit sequence generated at block 1004 of the process 1000 of FIG. 10.

At block 1106, the network device (or component thereof) can output, based on the interleaved CB bit sequence, a plurality of modulated symbols. For example, the plurality of modulated symbols output at block 1106 of the process 1100 of FIG. 11 can be the same as or similar to the plurality of modulated symbols output at block 1006 of the process 1000 of FIG. 10. In some cases, the plurality of modulated symbols includes a first set of quadrature amplitude modulation (QAM) modulated symbols corresponding to the first subset of coded bits, and a second set of quadrature phase shift keying (QPSK) modulated symbols corresponding to the second subset of coded bits. For example, the plurality of modulated symbols generated based on an interleaved CB bit sequence corresponding to the CB bit sequence 805 of FIG. 8 can include a first set of QAM modulated symbols generated by interleaving the first subset of coded bits corresponding to the first sub-band, using the first interleaver 820 of FIG. 8. In some cases, the plurality of modulated symbols generated based on an interleaved CB bit sequence corresponding to the CB bit sequence 805 of FIG. 8 can include a second set of QPSK modulated symbols generated by interleaving the second subset of coded bits corresponding to the second sub-band, using the second interleaver 840 of FIG. 8.

At block 1108, the network device (or component thereof) can transmit the plurality of modulated symbols using the plurality of sub-bands.

In some cases, the computing device or apparatus configured to perform the process 1000 and/or the process 1100 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 1000 and the process 1100 are illustrated as a logical flow diagram, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 1000, the process 1100, and/or other process described herein, may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 12 is a diagram illustrating an example of a system for implementing certain aspects of the present technology. In particular, FIG. 12 illustrates an example of computing system 1200 including a processing system 1202, which may be for example any computing device making up internal computing system, a remote computing system, a camera, or any component thereof in which the components of the system are in communication with each other using connection 1205. Connection 1205 may be a physical connection using a bus, or a direct connection into processor 1210 (and/or one or more other processors included within and/or associated with the processing system 1202), such as in a chipset architecture. Connection 1205 may also be a virtual connection, networked connection, or logical connection.

In some aspects, computing system 1200 and/or the processing system 1202 can be provided as a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

The example processing system 1202 includes at least one processing unit (CPU or processor) 1210 and connection 1205 that communicatively couples various system components including system memory 1215, such as read-only memory (ROM) 1220 and random access memory (RAM) 1225 to processor 1210. The processing system 1202 may include a cache 1212 of high-speed memory connected directly with, in close proximity to, or integrated as part of processor 1210 and/or one or more other processors included within and/or associated with the processing system 1202.

Processor 1210 may include any general-purpose processor and a hardware service or software service, such as services 1232, 1234, and 1236 stored in storage device 1230, configured to control processor 1210 and/or one or more other processors included within and/or associated with the processing system 1202, as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, processing system 1202 includes an input device 1245, which may represent any number of input mechanisms, such as a microphone for speech, a touch-sensitive screen for gesture or graphical input, keyboard, mouse, motion input, speech, etc. Processing system 1202 may also include output device 1235, which may be one or more of a number of output mechanisms. In some instances, multimodal systems may enable a user to provide multiple types of input/output to communicate with processing system 1202.

Processing system 1202 may include communications interface 1240, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1230 may include software services, servers, services, etc., that when the code that defines such software is executed by the processor 1210 and/or one or more other processors included within and/or associated with the processing system 1202, it causes the system to perform a function. In some aspects, a hardware service that performs a particular function may include the software component stored in a computer-readable medium in connection with the necessary hardware components, such as processor 1210 (e.g., and/or one or more other processors included within and/or associated with the processing system 1202), connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. A network entity for wireless communication, comprising: a processing system configured to: receive information indicative of a mapping between an input code-block (CB) bit sequence and a plurality of sub-bands; generate an interleaved CB bit sequence based on application of the mapping to a particular CB bit sequence, wherein each sub-band of the plurality of sub-bands is mapped to a respective subset of coded bits of a plurality of coded bits according to the mapping, wherein the particular CB bit sequence includes the plurality of coded bits, and wherein the plurality of coded bits includes a plurality of subsets of coded bits; and output, based on the interleaved CB bit sequence, a plurality of modulated symbols.

Aspect 2. The network entity of Aspect 1, wherein, to generate the interleaved CB bit sequence, the processing system is configured to: process the plurality of coded bits using a plurality of interleavers, wherein each interleaver of the plurality of interleavers corresponds to a respective sub-band of the plurality of sub-bands.

Aspect 3. The network entity of Aspect 2, wherein, to process the plurality of coded bits using the plurality of interleavers, the processing system is configured to process each subset of coded bits of the plurality of subsets of coded bits using a respective interleaver of the plurality of interleavers.

Aspect 4. The network entity of any of Aspects 2 to 3, wherein a quantity of interleavers included in the plurality of interleavers is the same as a quantity of sub-bands included in the plurality of sub-bands.

Aspect 5. The network entity of any of Aspects 1 to 4, wherein, to generate the interleaved CB bit sequence, the processing system is configured to process each subset of coded bits of the plurality of subsets of coded bits using a single interleaver.

Aspect 6. The network entity of any of Aspects 1 to 5, wherein the processing system is configured to process each subset of coded bits of the plurality of subsets of coded bits using a portion of a single interleaver.

Aspect 7. The network entity of any of Aspects 1 to 6, wherein an aggregated bandwidth includes the plurality of sub-bands, and wherein a scheduled transmission of a transport block (TB) corresponds to the particular CB bit sequence.

Aspect 8. The network entity of Aspect 7, wherein the TB includes the plurality of modulated symbols.

Aspect 9. The network entity of any of Aspects 1 to 8, wherein the plurality of sub-bands comprises a plurality of component carriers associated with carrier aggregation by the network entity.

Aspect 10. The network entity of any of Aspects 1 to 9, wherein the plurality of sub-bands is associated with a virtual carrier configured for flexible spectrum integration (FSI).

Aspect 11. The network entity of any of Aspects 1 to 10, wherein, to generate the interleaved CB bit sequence, the processing system is configured to: determine, based on the mapping, each respective subset of coded bits of the plurality of subsets of coded bits mapped to each sub-band of the plurality of sub-bands; and cause each respective subset of coded bits of the plurality of subsets of coded bits to be processed by one or more interleavers of the processing system.

Aspect 12. The network entity of any of Aspects 1 to 11, wherein the mapping is between the input CB bit sequence and a plurality of columns corresponding to one or more interleavers of the processing system, wherein each sub-band of the plurality of sub-bands corresponds to a respective subset of one or more columns of the plurality of columns.

Aspect 13. The network entity of any of Aspects 1 to 12, wherein the information includes an indication of a starting bit position for the mapping within one or more of the input CB bit sequence or the particular CB bit sequence.

Aspect 14. The network entity of any of Aspects 1 to 13, wherein each subset of coded bits of the plurality of subsets of coded bits includes consecutive bits within the input CB bit sequence based on the mapping.

Aspect 15. The network entity of any of Aspects 1 to 14, wherein the mapping is between respective bit positions within the input CB bit sequence and respective sub-band indices associated with the plurality of sub-bands.

Aspect 16. The network entity of any of Aspects 1 to 15, wherein, according to the mapping, each subset of coded bits of the plurality of subsets of coded bits includes: a respective set of one or more systematic bits of the particular CB bit sequence; and a respective set of one or more parity bits of the input CB bit sequence.

Aspect 17. The network entity of any of Aspects 1 to 16, wherein the mapping is based on link quality information corresponding to the plurality of sub-bands.

Aspect 18. The network entity of Aspect 17, wherein the link quality information comprises one or more of: channel condition information corresponding to the plurality of sub-bands; or interference information corresponding to the plurality of sub-bands.

Aspect 19. The network entity of any of Aspects 17 to 18, wherein the mapping is based on one or more of: a respective modulation order for each sub-band of the plurality of sub-bands; or a respective rank configured for each sub-band of the plurality of sub-bands.

Aspect 20. The network entity of any of Aspects 17 to 19, wherein the processing system is configured to determine the link quality information.

Aspect 21. The network entity of any of Aspects 1 to 20, wherein the processing system is configured to: determine the mapping based on link quality information corresponding to the plurality of sub-bands; and transmit a request to use the mapping.

Aspect 22. The network entity of Aspect 21, wherein the information indicates permission to use the mapping.

Aspect 23. The network entity of any of Aspects 1 to 22, wherein the mapping is based on capability information corresponding to one or more interleavers of the processing system, wherein the one or more interleavers are used to generate the interleaved CB bit sequence based on application of the mapping to the particular CB bit sequence.

Aspect 24. The network entity of any of Aspects 1 to 23, wherein, to receive the information, the processing system is configured to receive signaling including the information, wherein the signaling includes radio resource control (RRC) signaling or media access control (MAC)-control element (MAC-CE) signaling.

Aspect 25. The network entity of any of Aspects 1 to 24, wherein, to receive the information, the processing system is configured to receive a physical downlink control channel (PDCCH) transmission including the information.

Aspect 26. The network entity of any of Aspects 1 to 25, wherein the network entity is a user equipment (UE), and wherein, to receive the information, the processing system is configured to receive the information from a second network entity.

Aspect 27. The network entity of any of Aspects 1 to 26, wherein: the plurality of sub-bands includes a first sub-band and a second sub-band; the first sub-band is mapped to a first subset of coded bits of the plurality of subsets of coded bits of the plurality of coded bits according to the mapping; and the second sub-band is mapped to a second subset of coded bits of the plurality of subsets of coded bits of the plurality of coded bits according to the mapping.

Aspect 28. The network entity of Aspect 27, wherein the plurality of modulated symbols includes: a first set of quadrature amplitude modulation (QAM) modulated symbols corresponding to the first subset of coded bits, and a second set of quadrature phase shift keying (QPSK) modulated symbols corresponding to the second subset of coded bits.

Aspect 29. The network entity of any of Aspects 27 to 28, wherein: the mapping is indicative of a first modulation order for the first subset of coded bits and a second modulation order for the second subset of coded bits; and to generate the interleaved CB bit sequence, the processing system is configured to cause the first subset of coded bits to be processed by a first interleaver based on the first modulation order.

Aspect 30. The network entity of Aspect 29, wherein: to generate the interleaved CB bit sequence, the processing system is configured to cause the second subset of coded bits to be processed by a second interleaver based on the second modulation order.

Aspect 31. A method for wireless communication by a network entity, the method comprising: receiving information indicative of a mapping between an input code-block (CB) bit sequence and a plurality of sub-bands; generating an interleaved CB bit sequence based on application of the mapping to a particular CB bit sequence, wherein each sub-band of the plurality of sub-bands is mapped to a respective subset of coded bits of a plurality of coded bits according to the mapping, wherein the particular CB bit sequence includes the plurality of coded bits, and wherein the plurality of coded bits includes a plurality of subsets of coded bits; and outputting, based on the interleaved CB bit sequence, a plurality of modulated symbols.

Aspect 32. The method of Aspect 31, wherein generating the interleaved CB bit sequence includes: processing the plurality of coded bits using a plurality of interleavers, wherein each interleaver of the plurality of interleavers corresponds to a respective sub-band of the plurality of sub-bands.

Aspect 33. The method of Aspect 32, wherein processing the plurality of coded bits using the plurality of interleavers comprises processing each subset of coded bits of the plurality of subsets of coded bits using a respective interleaver of the plurality of interleavers.

Aspect 34. The method of any of Aspects 32 to 33, wherein a quantity of interleavers included in the plurality of interleavers is the same as a quantity of sub-bands included in the plurality of sub-bands.

Aspect 35. The method of any of Aspects 31 to 34, wherein generating the interleaved CB bit sequence includes processing each subset of coded bits of the plurality of subsets of coded bits using a single interleaver.

Aspect 36. The method of any of Aspects 31 to 25, further comprising processing each subset of coded bits of the plurality of subsets of coded bits using a portion of a single interleaver.

Aspect 37. The method of any of Aspects 31 to 26, wherein an aggregated bandwidth includes the plurality of sub-bands, and wherein a scheduled transmission of a transport block (TB) corresponds to the particular CB bit sequence.

Aspect 38. The method of Aspect 37, wherein the TB includes the plurality of modulated symbols.

Aspect 39. The method of any of Aspects 31 to 38, wherein the plurality of sub-bands comprises a plurality of component carriers associated with carrier aggregation by the network entity.

Aspect 40. The method of any of Aspects 31 to 39, wherein the plurality of sub-bands is associated with a virtual carrier configured for flexible spectrum integration (FSI).

Aspect 41. The method of any of Aspects 31 to 40, wherein generating the interleaved CB bit sequence includes: determining, based on the mapping, each respective subset of coded bits of the plurality of subsets of coded bits mapped to each sub-band of the plurality of sub-bands; and causing each respective subset of coded bits of the plurality of subsets of coded bits to be processed by one or more interleavers of the processing system.

Aspect 42. The method of any of Aspects 31 to 41, wherein the mapping is between the input CB bit sequence and a plurality of columns corresponding to one or more interleavers of a processing system of the network entity, and wherein each sub-band of the plurality of sub-bands corresponds to a respective subset of one or more columns of the plurality of columns.

Aspect 43. The method of any of Aspects 31 to 42, wherein the information includes an indication of a starting bit position for the mapping within one or more of the input CB bit sequence or the particular CB bit sequence.

Aspect 44. The method of any of Aspects 31 to 43, wherein each subset of coded bits of the plurality of subsets of coded bits includes consecutive bits within the input CB bit sequence based on the mapping.

Aspect 45. The method of any of Aspects 31 to 44, wherein the mapping is between respective bit positions within the input CB bit sequence and respective sub-band indices associated with the plurality of sub-bands.

Aspect 46. The method of any of Aspects 31 to 45, wherein, according to the mapping, each subset of coded bits of the plurality of subsets of coded bits includes: a respective set of one or more systematic bits of the particular CB bit sequence; and a respective set of one or more parity bits of the input CB bit sequence.

Aspect 47. The method of any of Aspects 31 to 46, wherein the mapping is based on link quality information corresponding to the plurality of sub-bands.

Aspect 48. The method of Aspect 47, wherein the link quality information comprises one or more of: channel condition information corresponding to the plurality of sub-bands; or interference information corresponding to the plurality of sub-bands.

Aspect 49. The method of any of Aspects 47 to 48, wherein the mapping is based on one or more of: a respective modulation order for each sub-band of the plurality of sub-bands; or a respective rank configured for each sub-band of the plurality of sub-bands.

Aspect 50. The method of any of Aspects 47 to 49, further comprising determining the link quality information.

Aspect 51. The method of any of Aspects 31 to 50, further comprising: determining the mapping based on link quality information corresponding to the plurality of sub-bands; and transmitting a request to use the mapping.

Aspect 52. The method of Aspect 51, wherein the information indicates permission to use the mapping.

Aspect 53. The method of any of Aspects 31 to 52, wherein the mapping is based on capability information corresponding to one or more interleavers of a processing system of the network entity, wherein the one or more interleavers are used to generate the interleaved CB bit sequence based on application of the mapping to the particular CB bit sequence.

Aspect 54. The method of any of Aspects 31 to 53, wherein receiving the information comprises receiving signaling including the information, wherein the signaling includes radio resource control (RRC) signaling or media access control (MAC)-control element (MAC-CE) signaling.

Aspect 55. The method of any of Aspects 31 to 54, wherein receiving the information comprises receiving a physical downlink control channel (PDCCH) transmission including the information.

Aspect 56. The method of any of Aspects 31 to 55, wherein the network entity is a user equipment (UE), and wherein receiving the information comprises receiving the information from a second network entity.

Aspect 57. The method of any of Aspects 31 to 56, wherein: the plurality of sub-bands includes a first sub-band and a second sub-band; the first sub-band is mapped to a first subset of coded bits of the plurality of subsets of coded bits of the plurality of coded bits according to the mapping; and the second sub-band is mapped to a second subset of coded bits of the plurality of subsets of coded bits of the plurality of coded bits according to the mapping.

Aspect 58. The method of Aspect 57, wherein the plurality of modulated symbols includes: a first set of quadrature amplitude modulation (QAM) modulated symbols corresponding to the first subset of coded bits, and a second set of quadrature phase shift keying (QPSK) modulated symbols corresponding to the second subset of coded bits.

Aspect 59. The method of any of Aspects 57 to 58, wherein: the mapping is indicative of a first modulation order for the first subset of coded bits and a second modulation order for the second subset of coded bits; and generating the interleaved CB bit sequence includes causing the first subset of coded bits to be processed by a first interleaver based on the first modulation order.

Aspect 60. The method of Aspect 59, wherein: generating the interleaved CB bit sequence includes causing the second subset of coded bits to be processed by a second interleaver based on the second modulation order.

Aspect 61. A network entity for wireless communication, comprising: a processing system configured to: transmit information indicative of a mapping between an input code-block (CB) bit sequence and a plurality of sub-bands; generate an interleaved CB bit sequence based on application of the mapping to a particular CB bit sequence, wherein each sub-band of the plurality of sub-bands is mapped to a respective subset of coded bits of a plurality of coded bits according to the mapping, wherein the particular CB bit sequence includes the plurality of coded bits, and wherein the plurality of coded bits includes a plurality of subsets of coded bits; and output, based on the interleaved CB bit sequence, a plurality of modulated symbols; and transmit the plurality of modulated symbols using the plurality of sub-bands.

Aspect 62. The network entity of Aspect 61, wherein, to generate the interleaved CB bit sequence, the processing system is configured to: process the plurality of coded bits using a plurality of interleavers, wherein each interleaver of the plurality of interleavers corresponds to a respective sub-band of the plurality of sub-bands.

Aspect 63. The network entity of Aspect 62, wherein, to process the plurality of coded bits using the plurality of interleavers, the processing system is configured to process each subset of coded bits of the plurality of subsets of coded bits using a respective interleaver of the plurality of interleavers.

Aspect 64. The network entity of any of Aspects 62 to 63, wherein a quantity of interleavers included in the plurality of interleavers is the same as a quantity of sub-bands included in the plurality of sub-bands.

Aspect 65. The network entity of any of Aspects 61 to 64, wherein, to generate the interleaved CB bit sequence, the processing system is configured to process each subset of coded bits of the plurality of subsets of coded bits using a single interleaver.

Aspect 66. The network entity of any of Aspects 61 to 65, wherein the processing system is configured to process each subset of coded bits of the plurality of subsets of coded bits using a portion of a single interleaver.

Aspect 67. The network entity of any of Aspects 61 to 66, wherein an aggregated bandwidth includes the plurality of sub-bands, and wherein a scheduled transmission of a transport block (TB) corresponds to the particular CB bit sequence.

Aspect 68. The network entity of Aspect 67, wherein the TB includes the plurality of modulated symbols.

Aspect 69. The network entity of any of Aspects 61 to 68, wherein the plurality of sub-bands comprises a plurality of component carriers associated with carrier aggregation by the network entity.

Aspect 70. The network entity of any of Aspects 61 to 69, wherein the plurality of sub-bands is associated with a virtual carrier configured for flexible spectrum integration (FSI).

Aspect 71. The network entity of any of Aspects 61 to 70, wherein, to generate the interleaved CB bit sequence, the processing system is configured to: determine, based on the mapping, each respective subset of coded bits of the plurality of subsets of coded bits mapped to each sub-band of the plurality of sub-bands; and cause each respective subset of coded bits of the plurality of subsets of coded bits to be processed by one or more interleavers of the processing system.

Aspect 72. The network entity of any of Aspects 61 to 71, wherein the mapping is between the input CB bit sequence and a plurality of columns corresponding to one or more interleavers of the processing system, wherein each sub-band of the plurality of sub-bands corresponds to a respective subset of one or more columns of the plurality of columns.

Aspect 73. The network entity of any of Aspects 61 to 72, wherein the information includes an indication of a starting bit position for the mapping within one or more of the input CB bit sequence or the particular CB bit sequence.

Aspect 74. The network entity of any of Aspects 61 to 73, wherein each subset of coded bits of the plurality of subsets of coded bits includes consecutive bits within the input CB bit sequence based on the mapping.

Aspect 75. The network entity of any of Aspects 61 to 74, wherein the mapping is between respective bit positions within the input CB bit sequence and respective sub-band indices associated with the plurality of sub-bands.

Aspect 76. The network entity of any of Aspects 61 to 75, wherein, according to the mapping, each subset of coded bits of the plurality of subsets of coded bits includes: a respective set of one or more systematic bits of the particular CB bit sequence; and a respective set of one or more parity bits of the input CB bit sequence.

Aspect 77. The network entity of any of Aspects 61 to 76, wherein the mapping is based on link quality information corresponding to the plurality of sub-bands.

Aspect 78. The network entity of Aspect 77, wherein the link quality information comprises one or more of: channel condition information corresponding to the plurality of sub-bands; or interference information corresponding to the plurality of sub-bands.

Aspect 79. The network entity of any of Aspects 77 to 78, wherein the mapping is based on one or more of: a respective modulation order for each sub-band of the plurality of sub-bands; or a respective rank configured for each sub-band of the plurality of sub-bands.

Aspect 80. The network entity of any of Aspects 77 to 79, wherein the processing system is configured to determine the link quality information.

Aspect 81. The network entity of any of Aspects 61 to 80, wherein the processing system is configured to: receive a request to use the mapping; and transmit the information indicative of the mapping in response to the request to use the mapping.

Aspect 82. The network entity of Aspect 81, wherein the information indicates permission to use the mapping.

Aspect 83. The network entity of any of Aspects 61 to 82, wherein the mapping is based on capability information corresponding to one or more interleavers of the processing system, wherein the one or more interleavers are used to generate the interleaved CB bit sequence based on application of the mapping to the particular CB bit sequence.

Aspect 84. The network entity of any of Aspects 61 to 83, wherein, to transmit the information, the processing system is configured to transmit signaling including the information, wherein the signaling includes radio resource control (RRC) signaling or media access control (MAC)-control element (MAC-CE) signaling.

Aspect 85. The network entity of any of Aspects 61 to 84, wherein, to transmit the information, the processing system is configured to transmit a physical downlink control channel (PDCCH) transmission including the information.

Aspect 86. The network entity of any of Aspects 61 to 85, wherein the network entity is a user equipment (UE), and wherein, to transmit the information, the processing system is configured to transmit the information to a second network entity.

Aspect 87. The network entity of any of Aspects 61 to 86, wherein: the plurality of sub-bands includes a first sub-band and a second sub-band; the first sub-band is mapped to a first subset of coded bits of the plurality of subsets of coded bits of the plurality of coded bits according to the mapping; and the second sub-band is mapped to a second subset of coded bits of the plurality of subsets of coded bits of the plurality of coded bits according to the mapping.

Aspect 88. The network entity of Aspect 87, wherein the plurality of modulated symbols includes: a first set of quadrature amplitude modulation (QAM) modulated symbols corresponding to the first subset of coded bits, and a second set of quadrature phase shift keying (QPSK) modulated symbols corresponding to the second subset of coded bits.

Aspect 89. The network entity of any of Aspects 87 to 88, wherein: the mapping is indicative of a first modulation order for the first subset of coded bits and a second modulation order for the second subset of coded bits; and to generate the interleaved CB bit sequence, the processing system is configured to cause the first subset of coded bits to be processed by a first interleaver based on the first modulation order.

Aspect 90. The network entity of Aspect 89, wherein: to generate the interleaved CB bit sequence, the processing system is configured to cause the second subset of coded bits to be processed by a second interleaver based on the second modulation order.

Aspect 91. A method for wireless communication by a network entity, the method comprising: transmitting information indicative of a mapping between an input code-block (CB) bit sequence and a plurality of sub-bands; generating an interleaved CB bit sequence based on application of the mapping to a particular CB bit sequence, wherein each sub-band of the plurality of sub-bands is mapped to a respective subset of coded bits of a plurality of coded bits according to the mapping, wherein the particular CB bit sequence includes the plurality of coded bits, and wherein the plurality of coded bits includes a plurality of subsets of coded bits; outputting, based on the interleaved CB bit sequence, a plurality of modulated symbols; and transmitting the plurality of modulated symbols using the plurality of sub-bands.

Aspect 92. The method of Aspect 91, wherein generating the interleaved CB bit sequence includes: processing the plurality of coded bits using a plurality of interleavers, wherein each interleaver of the plurality of interleavers corresponds to a respective sub-band of the plurality of sub-bands.

Aspect 93. The method of Aspect 92, wherein processing the plurality of coded bits using the plurality of interleavers comprises processing each subset of coded bits of the plurality of subsets of coded bits using a respective interleaver of the plurality of interleavers.

Aspect 94. The method of any of Aspects 92 to 93, wherein a quantity of interleavers included in the plurality of interleavers is the same as a quantity of sub-bands included in the plurality of sub-bands.

Aspect 95. The method of any of Aspects 91 to 94, wherein generating the interleaved CB bit sequence includes processing each subset of coded bits of the plurality of subsets of coded bits using a single interleaver.

Aspect 96. The method of any of Aspects 91 to 95, further comprising processing each subset of coded bits of the plurality of subsets of coded bits using a portion of a single interleaver.

Aspect 97. The method of any of Aspects 91 to 96, wherein an aggregated bandwidth includes the plurality of sub-bands, and wherein a scheduled transmission of a transport block (TB) corresponds to the particular CB bit sequence.

Aspect 98. The method of Aspect 97, wherein the TB includes the plurality of modulated symbols.

Aspect 99. The method of any of Aspects 91 to 98, wherein the plurality of sub-bands comprises a plurality of component carriers associated with carrier aggregation by the network entity.

Aspect 100. The method of any of Aspects 91 to 99, wherein the plurality of sub-bands is associated with a virtual carrier configured for flexible spectrum integration (FSI).

Aspect 101. The method of any of Aspects 91 to 100, wherein generating the interleaved CB bit sequence includes: determining, based on the mapping, each respective subset of coded bits of the plurality of subsets of coded bits mapped to each sub-band of the plurality of sub-bands; and causing each respective subset of coded bits of the plurality of subsets of coded bits to be processed by one or more interleavers of the processing system.

Aspect 102. The method of any of Aspects 91 to 101, wherein the mapping is between the input CB bit sequence and a plurality of columns corresponding to one or more interleavers of a processing system of the network entity, and wherein each sub-band of the plurality of sub-bands corresponds to a respective subset of one or more columns of the plurality of columns.

Aspect 103. The method of any of Aspects 91 to 102, wherein the information includes an indication of a starting bit position for the mapping within one or more of the input CB bit sequence or the particular CB bit sequence.

Aspect 104. The method of any of Aspects 91 to 103, wherein each subset of coded bits of the plurality of subsets of coded bits includes consecutive bits within the input CB bit sequence based on the mapping.

Aspect 105. The method of any of Aspects 91 to 104, wherein the mapping is between respective bit positions within the input CB bit sequence and respective sub-band indices associated with the plurality of sub-bands.

Aspect 106. The method of any of Aspects 91 to 105, wherein, according to the mapping, each subset of coded bits of the plurality of subsets of coded bits includes: a respective set of one or more systematic bits of the particular CB bit sequence; and a respective set of one or more parity bits of the input CB bit sequence.

Aspect 107. The method of any of Aspects 91 to 106, wherein the mapping is based on link quality information corresponding to the plurality of sub-bands.

Aspect 108. The method of Aspect 107, wherein the link quality information comprises one or more of: channel condition information corresponding to the plurality of sub-bands; or interference information corresponding to the plurality of sub-bands.

Aspect 109. The method of any of Aspects 107 to 108, wherein the mapping is based on one or more of: a respective modulation order for each sub-band of the plurality of sub-bands; or a respective rank configured for each sub-band of the plurality of sub-bands.

Aspect 110. The method of any of Aspects 107 to 109, further comprising determining the link quality information.

Aspect 111. The method of any of Aspects 91 to 110, further comprising: receiving a request to use the mapping; and transmitting the information indicative of the mapping in response to the request to use the mapping.

Aspect 112. The method of Aspect 111, wherein the information indicates permission to use the mapping.

Aspect 113. The method of any of Aspects 91 to 112, wherein the mapping is based on capability information corresponding to one or more interleavers of a processing system of the network entity, wherein the one or more interleavers are used to generate the interleaved CB bit sequence based on application of the mapping to the particular CB bit sequence.

Aspect 114. The method of any of Aspects 91 to 113, wherein transmitting the information comprises transmitting signaling including the information, wherein the signaling includes radio resource control (RRC) signaling or media access control (MAC)-control element (MAC-CE) signaling.

Aspect 115. The method of any of Aspects 91 to 114, wherein transmitting the information comprises transmitting a physical downlink control channel (PDCCH) transmission including the information.

Aspect 116. The method of any of Aspects 91 to 115, wherein the network entity is a user equipment (UE), and wherein transmitting the information comprises transmitting the information to a second network entity.

Aspect 117. The method of any of Aspects 91 to 116, wherein: the plurality of sub-bands includes a first sub-band and a second sub-band; the first sub-band is mapped to a first subset of coded bits of the plurality of subsets of coded bits of the plurality of coded bits according to the mapping; and the second sub-band is mapped to a second subset of coded bits of the plurality of subsets of coded bits of the plurality of coded bits according to the mapping.

Aspect 118. The method of Aspect 117, wherein the plurality of modulated symbols includes: a first set of quadrature amplitude modulation (QAM) modulated symbols corresponding to the first subset of coded bits, and a second set of quadrature phase shift keying (QPSK) modulated symbols corresponding to the second subset of coded bits.

Aspect 119. The method of any of Aspects 117 to 118, wherein: the mapping is indicative of a first modulation order for the first subset of coded bits and a second modulation order for the second subset of coded bits; and generating the interleaved CB bit sequence includes causing the first subset of coded bits to be processed by a first interleaver based on the first modulation order.

Aspect 120. The method of Aspect 119, wherein: generating the interleaved CB bit sequence includes causing the second subset of coded bits to be processed by a second interleaver based on the second modulation order.

Aspect 121. A method for wireless communication, comprising performing operations according to any of Aspects 1 to 30.

Aspect 122. A method for wireless communication, comprising performing operations according to any of Aspects 61 to 90.

Aspect 123. A non-transitory computer-readable storage medium comprising instructions stored thereon which, when executed by at least one processor, causes the at least one processor to perform operations according to any of Aspects 1 to 30 or 61 to 90.

Aspect 124. A non-transitory computer-readable storage medium comprising instructions stored thereon which, when executed by at least one processor, causes the at least one processor to perform operations according to any of Aspects 31 to 60 or 91 to 120.

Aspect 125. An apparatus for wireless communication comprising one or more means for performing operations according to any of Aspects 1 to 30.

Aspect 126. An apparatus for wireless communication comprising one or more means for performing operations according to any of Aspects 31 to 60.

Aspect 127. An apparatus for wireless communication comprising one or more means for performing operations according to any of Aspects 61 to 90.

Aspect 128. An apparatus for wireless communication comprising one or more means for performing operations according to any of Aspects 91 to 120.

Aspect 129. The network entity of any of Aspects 1 to 30, wherein, to generate the interleaved CB bit sequence, the processing system is configured to: process the plurality of coded bits using one or more interleavers, wherein each interleaver of the one or more interleavers corresponds to a respective subset of sub-bands of the plurality of sub-bands.

Aspect 130. The network entity of Aspect 129, wherein a quantity of interleavers included in the one or more interleavers is less than a quantity of sub-bands included in the plurality of sub-bands.

Aspect 131. The network entity of any of Aspects 129 to 130, wherein, to process the plurality of coded bits using the one or more interleavers, the processing system is configured to: process a first portion of the plurality of coded bits using a first interleaver of the one or more interleavers, wherein the first interleaver corresponds to a first subset of sub-bands of the plurality of sub-bands, and wherein the first portion of the plurality of coded bits includes the respective subset of coded bits mapped to each sub-band of the first subset of sub-bands; and process a second portion of the plurality of coded bits using a second interleaver of the one or more interleavers, wherein the second interleaver corresponds to a second subset of sub-bands of the plurality of sub-bands, and wherein the second portion of the plurality of coded bits includes the respective subset of coded bits mapped to each sub-band of the second subset of sub-bands.

Aspect 132. The method of any of Aspects 31 to 60, wherein generating the interleaved CB bit sequence includes processing the plurality of coded bits using one or more interleavers, wherein each interleaver of the one or more interleavers corresponds to a respective subset of sub-bands of the plurality of sub-bands.

Aspect 133. The method of Aspect 132, wherein a quantity of interleavers included in the one or more interleavers is less than a quantity of sub-bands included in the plurality of sub-bands.

Aspect 134. The method of any of Aspects 132 to 133, wherein processing the plurality of coded bits using the one or more interleavers comprises: processing a first portion of the plurality of coded bits using a first interleaver of the one or more interleavers, wherein the first interleaver corresponds to a first subset of sub-bands of the plurality of sub-bands, and wherein the first portion of the plurality of coded bits includes the respective subset of coded bits mapped to each sub-band of the first subset of sub-bands; and processing a second portion of the plurality of coded bits using a second interleaver of the one or more interleavers, wherein the second interleaver corresponds to a second subset of sub-bands of the plurality of sub-bands, and wherein the second portion of the plurality of coded bits includes the respective subset of coded bits mapped to each sub-band of the second subset of sub-bands.

Aspect 135. The network entity of any of Aspects 61 to 90, wherein, to generate the interleaved CB bit sequence, the processing system is configured to: process the plurality of coded bits using one or more interleavers, wherein each interleaver of the one or more interleavers corresponds to a respective subset of sub-bands of the plurality of sub-bands.

Aspect 136. The network entity of Aspect 135, wherein a quantity of interleavers included in the one or more interleavers is less than a quantity of sub-bands included in the plurality of sub-bands.

Aspect 137. The network entity of any of Aspects 135 to 136, wherein, to process the plurality of coded bits using the one or more interleavers, the processing system is configured to: process a first portion of the plurality of coded bits using a first interleaver of the one or more interleavers, wherein the first interleaver corresponds to a first subset of sub-bands of the plurality of sub-bands, and wherein the first portion of the plurality of coded bits includes the respective subset of coded bits mapped to each sub-band of the first subset of sub-bands; and process a second portion of the plurality of coded bits using a second interleaver of the one or more interleavers, wherein the second interleaver corresponds to a second subset of sub-bands of the plurality of sub-bands, and wherein the second portion of the plurality of coded bits includes the respective subset of coded bits mapped to each sub-band of the second subset of sub-bands.

Aspect 138. The method of any of Aspects 91 to 120, wherein generating the interleaved CB bit sequence includes processing the plurality of coded bits using one or more interleavers, wherein each interleaver of the one or more interleavers corresponds to a respective subset of sub-bands of the plurality of sub-bands.

Aspect 139. The method of Aspect 138, wherein a quantity of interleavers included in the one or more interleavers is less than a quantity of sub-bands included in the plurality of sub-bands.

Aspect 140. The method of any of Aspects 138 to 139, wherein processing the plurality of coded bits using the one or more interleavers comprises: processing a first portion of the plurality of coded bits using a first interleaver of the one or more interleavers, wherein the first interleaver corresponds to a first subset of sub-bands of the plurality of sub-bands, and wherein the first portion of the plurality of coded bits includes the respective subset of coded bits mapped to each sub-band of the first subset of sub-bands; and processing a second portion of the plurality of coded bits using a second interleaver of the one or more interleavers, wherein the second interleaver corresponds to a second subset of sub-bands of the plurality of sub-bands, and wherein the second portion of the plurality of coded bits includes the respective subset of coded bits mapped to each sub-band of the second subset of sub-bands.

What is claimed is:

1. A network entity for wireless communication, comprising:
a processing system configured to:
receive information indicative of a mapping between an input code-block (CB) bit sequence and a plurality of sub-bands;
generate an interleaved CB bit sequence based on application of the mapping to a particular CB bit sequence, wherein each sub-band of the plurality of sub-bands is mapped to a respective subset of coded bits of a plurality of coded bits according to the mapping, wherein the particular CB bit sequence includes the plurality of coded bits, and wherein the plurality of coded bits includes a plurality of subsets of coded bits; and
output, based on the interleaved CB bit sequence, a plurality of modulated symbols.

2. The network entity of claim 1, wherein, to generate the interleaved CB bit sequence, the processing system is configured to:
process the plurality of coded bits using a plurality of interleavers, wherein each interleaver of the plurality of interleavers corresponds to a respective sub-band of the plurality of sub-bands.

3. The network entity of claim 2, wherein, to process the plurality of coded bits using the plurality of interleavers, the processing system is configured to process each subset of coded bits of the plurality of subsets of coded bits using a respective interleaver of the plurality of interleavers.

4. The network entity of claim 2, wherein a quantity of interleavers included in the plurality of interleavers is the same as a quantity of sub-bands included in the plurality of sub-bands.

5. The network entity of claim 1, wherein, to generate the interleaved CB bit sequence, the processing system is configured to process each subset of coded bits of the plurality of subsets of coded bits using a single interleaver.

6. The network entity of claim 1, wherein the processing system is configured to process each subset of coded bits of the plurality of subsets of coded bits using a portion of a single interleaver.

7. The network entity of claim 1, wherein an aggregated bandwidth includes the plurality of sub-bands, and wherein a scheduled transmission of a transport block (TB) corresponds to the particular CB bit sequence.

8. The network entity of claim 7, wherein the TB includes the plurality of modulated symbols.

9. The network entity of claim 1, wherein the plurality of sub-bands comprises a plurality of component carriers associated with carrier aggregation by the network entity.

10. The network entity of claim 1, wherein the plurality of sub-bands is associated with a virtual carrier configured for flexible spectrum integration (FSI).

11. The network entity of claim 1, wherein, to generate the interleaved CB bit sequence, the processing system is configured to:
determine, based on the mapping, each respective subset of coded bits of the plurality of subsets of coded bits mapped to each sub-band of the plurality of sub-bands; and
cause each respective subset of coded bits of the plurality of subsets of coded bits to be processed by one or more interleavers of the processing system.

12. The network entity of claim 1, wherein the mapping is between the input CB bit sequence and a plurality of columns corresponding to one or more interleavers of the processing system, wherein each sub-band of the plurality of sub-bands corresponds to a respective subset of one or more columns of the plurality of columns.

13. The network entity of claim 1, wherein the information includes an indication of a starting bit position for the mapping within one or more of the input CB bit sequence or the particular CB bit sequence.

14. The network entity of claim 1, wherein each subset of coded bits of the plurality of subsets of coded bits includes consecutive bits within the input CB bit sequence based on the mapping.

15. The network entity of claim 1, wherein the mapping is between respective bit positions within the input CB bit sequence and respective sub-band indices associated with the plurality of sub-bands.

16. The network entity of claim 1, wherein, according to the mapping, each subset of coded bits of the plurality of subsets of coded bits includes:
a respective set of one or more systematic bits of the particular CB bit sequence; and
a respective set of one or more parity bits of the input CB bit sequence.

17. The network entity of claim 1, wherein the mapping is based on link quality information corresponding to the plurality of sub-bands.

18. The network entity of claim 17, wherein the link quality information comprises one or more of:
channel condition information corresponding to the plurality of sub-bands; or
interference information corresponding to the plurality of sub-bands.

19. The network entity of claim 17, wherein the mapping is based on one or more of:
a respective modulation order for each sub-band of the plurality of sub-bands; or
a respective rank configured for each sub-band of the plurality of sub-bands.

20. The network entity of claim 17, wherein the processing system is configured to determine the link quality information.

21. The network entity of claim 1, wherein the processing system is configured to:
determine the mapping based on link quality information corresponding to the plurality of sub-bands; and
transmit a request to use the mapping.

22. The network entity of claim 21, wherein the information indicates permission to use the mapping.

23. The network entity of claim 1, wherein the mapping is based on capability information corresponding to one or more interleavers of the processing system, wherein the one or more interleavers are used to generate the interleaved CB bit sequence based on application of the mapping to the particular CB bit sequence.

24. The network entity of claim 1, wherein, to receive the information, the processing system is configured to receive signaling including the information, wherein the signaling includes radio resource control (RRC) signaling or media access control (MAC)-control element (MAC-CE) signaling.

25. The network entity of claim 1, wherein, to receive the information, the processing system is configured to receive a physical downlink control channel (PDCCH) transmission including the information.

26. The network entity of claim 1, wherein the network entity is a user equipment (UE), and wherein, to receive the information, the processing system is configured to receive the information from a second network entity.

27. The network entity of claim 1, wherein:
the plurality of sub-bands includes a first sub-band and a second sub-band;
the first sub-band is mapped to a first subset of coded bits of the plurality of subsets of coded bits of the plurality of coded bits according to the mapping; and
the second sub-band is mapped to a second subset of coded bits of the plurality of subsets of coded bits of the plurality of coded bits according to the mapping.

28. The network entity of claim 27, wherein the plurality of modulated symbols includes:
a first set of quadrature amplitude modulation (QAM) modulated symbols corresponding to the first subset of coded bits, and
a second set of quadrature phase shift keying (QPSK) modulated symbols corresponding to the second subset of coded bits.

29. The network entity of claim 27, wherein:
the mapping is indicative of a first modulation order for the first subset of coded bits and a second modulation order for the second subset of coded bits; and
to generate the interleaved CB bit sequence, the processing system is configured to cause the first subset of coded bits to be processed by a first interleaver based on the first modulation order.

30. The network entity of claim 29, wherein:
to generate the interleaved CB bit sequence, the processing system is configured to cause the second subset of coded bits to be processed by a second interleaver based on the second modulation order.

31. The network entity of claim 1, wherein, to generate the interleaved CB bit sequence, the processing system is configured to:
process the plurality of coded bits using one or more interleavers, wherein each interleaver of the one or more interleavers corresponds to a respective subset of sub-bands of the plurality of sub-bands.

32. The network entity of claim 31, wherein a quantity of interleavers included in the one or more interleavers is less than a quantity of sub-bands included in the plurality of sub-bands.

33. The network entity of claim 31, wherein, to process the plurality of coded bits using the one or more interleavers, the processing system is configured to:
process a first portion of the plurality of coded bits using a first interleaver of the one or more interleavers, wherein the first interleaver corresponds to a first subset of sub-bands of the plurality of sub-bands, and wherein the first portion of the plurality of coded bits includes the respective subset of coded bits mapped to each sub-band of the first subset of sub-bands; and
process a second portion of the plurality of coded bits using a second interleaver of the one or more interleavers, wherein the second interleaver corresponds to a second subset of sub-bands of the plurality of sub-bands, and wherein the second portion of the plurality of coded bits includes the respective subset of coded bits mapped to each sub-band of the second subset of sub-bands.

34. A method for wireless communication by a network entity, the method comprising:
receiving information indicative of a mapping between an input code-block (CB) bit sequence and a plurality of sub-bands;
generating an interleaved CB bit sequence based on application of the mapping to a particular CB bit sequence, wherein each sub-band of the plurality of sub-bands is mapped to a respective subset of coded bits of a plurality of coded bits according to the mapping, wherein the particular CB bit sequence includes the plurality of coded bits, and wherein the plurality of coded bits includes a plurality of subsets of coded bits; and
outputting, based on the interleaved CB bit sequence, a plurality of modulated symbols.

35. A network entity for wireless communication, comprising:
a processing system configured to:
transmit information indicative of a mapping between an input code-block (CB) bit sequence and a plurality of sub-bands;
generate an interleaved CB bit sequence based on application of the mapping to a particular CB bit sequence, wherein each sub-band of the plurality of sub-bands is mapped to a respective subset of coded bits of a plurality of coded bits according to the mapping, wherein the particular CB bit sequence includes the plurality of coded bits, and wherein the plurality of coded bits includes a plurality of subsets of coded bits;
output, based on the interleaved CB bit sequence, a plurality of modulated symbols; and
transmit the plurality of modulated symbols using the plurality of sub-bands.
